(19) United States
(12) Patent Application Publication
(10) Pub. No.: US 2014/0069506 A1
(43) Pub. Date: Mar. 13, 2014

(54) WATER MANAGEMENT CONTROL DEVICE FOR WATERING DEVICES

(71) Applicant: Partners In Innovation Limited, LLC, Cincinnati, OH (US)

(72) Inventors: John Helmsderfer, Cincinnati, OH (US); Andrew Ahr, Cincinnati, OH (US)

(73) Assignee: PARTNERS IN INNOVATION LIMITED, LLC, Cincinnati, OH (US)

(21) Appl. No.: 13/962,560

(22) Filed: Aug. 8, 2013

Related U.S. Application Data
(63) Continuation-in-part of application No. 13/526,361, filed on Jun. 18, 2012.
Application No. 13/526,361 is a continuation-in-part of application No. 13/184,325, filed on Jul. 15, 2011.
Application No. 13/184,325 is a continuation of application No. PCT/US2010/061063, filed on Dec. 17, 2010.
Application No. PCT/US2010/061063 is a continuation-in-part of application No. 13/411,119, filed on Mar. 2, 2012.
(60) Provisional application No. 61/681,059, filed on Aug. 8, 2012.
(60) Provisional application No. 61/498,411, filed on Jun. 17, 2011.
(60) Provisional application No. 61/449,362, filed on Mar. 4, 2011.

(51) Int. Cl. A01G 25/16

(52) U.S. Cl. CPC A01G 25/165
USPC 137/1; 137/624.11

(57) ABSTRACT

A water management control device is configured to operate in a time mode and a depth mode to control the flow of water through an internal passageway based on user-selected programming inputs relating to watering by time or watering by depth.

### RELATED APPLICATIONS

This application claims the benefit of U.S. Provisional Application No. 61/681,059, filed Aug. 8, 2012, the content of which is hereby incorporated by reference in this application in its entirety.

This application is also a continuation in part of U.S. patent application Ser. No. 13/526,361, filed Jun. 18, 2012, the content of which is hereby incorporated by reference in this application in its entirety. U.S. application Ser. No. 13/526,361 is a continuation-in-part of U.S. application Ser. No. 13/184,325, filed Jul. 15, 2011; claims priority from U.S. Provisional Application No. 61/498,411, filed Jun. 17, 2011; and is also a continuation of PCT/US2010/061063, filed Dec. 17, 2010, the contents of all of which are hereby incorporated by reference in this application in their entireties.

This application is also a continuation in part of U.S. patent application Ser. No. 13/411,119, filed Mar. 2, 2012, the content of which is hereby incorporated by reference in this application in its entirety. U.S. patent application Ser. No. 13/411,119 claims priority from U.S. Provisional Application No. 61/449,362, filed Mar. 4, 2011, the content of which is hereby incorporated by reference in this application in its entirety.

### TECHNICAL FIELD

The present invention relates to watering devices and, more particularly to water management control devices for controlling the flow of water to a watering device, such as a sprinkler.

### BACKGROUND OF THE INVENTION

Many landowners take a great interest in growing and maintaining good looking lawns and landscapes. This is often achieved, in part, by supplementing the volume of natural rain fall through the use of lawn sprinklers or in-ground irrigation systems. Water, however, is becoming an increasingly scarce resource. Developed countries such as the United States are beginning to experience regional water shortages; for example, in the Atlanta area and Southern California. Experts in the field of water management forecast that regional fresh water shortages such as these will likely increase over coming decades. Accordingly there is an increased need for conservation methods.

Turning to lawn sprinklers, one shortcoming of current sprinkler designs is the fact that they have no means to communicate to the user the depth of water distributed by the selected pattern's coverage area over a given period of time. For example, some sprinklers offer a semi circular pattern, others a full circle, others a square pattern and still others a rectangular pattern. Many horticulturists and seed developers use such figures in developing protocols or instructions for the care of various plants such as lawn grasses. With this in mind, a user wants to provide enough water using a sprinkler system to maximize plant health, but also wants to avoid overwatering for both plant health and conservation reasons. However, conventional sprinkler systems leave the user to make the depth over time quantification by other means. Furthermore, reconciling the results of such a calculation with varying amounts of rainfall between watering makes the task yet more difficult.

Although it is desirable to water by depth, certain consumers are in the habit of watering by time. Moreover, some retailers may be interested in limiting the number of distinct products that they stock. Such retailers might not be interested in stocking a product that is only capable of watering by depth especially if they feel strongly that their consumer base is accustomed to watering by time. Accordingly a device that facilitated watering by both time and depth would satisfy the needs of both consumers and retailers.

Another consideration affecting the success of water control devices is the ease of programming. Often the hobby of gardening is adopted by mature adults who may not be accustomed to devices with multifunction programming buttons. Such adults might resist purchasing a device if they believe that learning a programming process for the device is either not possible or will take a commitment that outweighs the benefit. Therefore it is desirable to provide water management devices that are easy to program and control.

Yet another consideration is the desire for consumers to readily identify the pattern that they have selected when using a watering device with a multi-pattern dial. Traditionally the consumer can look at the face of the dial or they can look at indicia printed on the side of the dial, but the location of this indicia may be less than desirable. Therefore it is desirable to provide watering devices that make it easy to observe a selected spray pattern.

A number of garden watering devices have been created to begin addressing these problems. Flow control valves, such as the type disclosed in U.S. Pat. No. 7,028,984 to Wang, allow an operator to control the output level of a lawn sprinkler attached to a water hose. Other devices, such as the type disclosed in U.S. Pat. No. 4,130,135 to Moore, are timers which allow the operator to set a sprinkler to only be operational for a predetermined period of time before actuating a valve that closes off water supply to the lawn sprinkler.

However, the aforementioned devices suffer from various drawbacks. Although these devices allow the operator to control the output level of a sprinkler or the period of time for which the sprinkler is operational, none of these devices allow the operator to accurately determine the volume of water being released over a period of time, due in part to varying flow pressure supplied by a spigot at different houses. Therefore, a landowner would still need to provide the additional accurate measuring means for determining how much water is being delivered to the lawn, particularly the depth. There would be no way to accurately provide a fixed volume of water in the recommended amount of inches per week using the conventional devices without constant monitoring of the system, which reduces the benefit of owning an automatic lawn sprinkler device. Thus, it would be desirable to provide a sprinkler system which helps a user sprinkle the desired amount of water and overcome these deficiencies of conventional sprinkler systems.

### SUMMARY OF THE INVENTION

Embodiments of the present invention relate to a water flow metering device for managing the amount of water sprayed from a sprinkler. In particular, the water flow metering device disclosed herein allows a user to control the volume of water sprayed from a sprinkler, thereby also providing control over the depth of water provided at the watered surface.

Understanding and controlling the depth of water provided from a sprinkler is advantageous in applications where watering recommendations are provided in terms of a depth of water per unit of time. For example, grass seed for a lawn may come with instructions that the ground containing freshly planted grass seed should be watered in an amount of one inch per day.

A water flow metering device as disclosed herein includes a shut-off valve disposed in a water passage of the device body of a sprinkler. A measuring device is disposed in the water passage for measuring water flowing through the water passage. A depth selection device allows a user to set the desired depth of water to be distributed. A controller is operable to open and close the shut-off valve, and the controller is configured to calculate a duration for the shut-off valve to remain open. The duration is based on the measurement of water flowing through the water passage and the desired depth set by a user.

Advantageously, the water flow metering device may be incorporated in several sprinkler designs. These include, for example, wand-style sprinklers, gear drive sprinklers, impulse or impact head sprinklers, elongate oscillatory sprinklers, single-pattern sprinklers such as whirling sprinklers, water pistols, and the like.

The flow metering device may also include or be associated with a timing mechanism including a timer for closing the shut-off valve after a set period of time. The flow metering device may also include or be associated with an accumulator for measuring an amount of natural rainfall, and the duration for the shut-off valve to remain open may be affected by the amount of natural rainfall.

Methods for distributing water with a sprinkler device over a surface are also provided, where the sprinkler device is operated for a duration to provide a desired depth amount of water. The duration is based on at least a user-selected depth amount and the volumetric flow rate of water that occurs through the sprinkler device.

A device for measuring flow of water and for providing depth over time information to a user is also provided. The device is positionable between a water source and a sprinkler having a known distribution pattern. The device includes a pressure gauge. An information chart is provided with the device that relates pressure, distribution patterns, and depth over time information. A chart interpretation tool is provided that may be used with the information chart.

A watering management control device is also provided and can be operated in a time mode and a depth mode in order to provide watering by time and watering by depth, respectively. The watering management control device includes a plurality of input selectors for setting user-defined input values that are relevant to watering applications, such as time, delay, frequency, depth, and outlet patterns. The watering management control device includes a blinder plate that is moveable between a first position and a second position, and the watering management control device is switched between the time mode and the depth mode when the blinder plate is moved between the first position and the second position.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a schematic view of the water flow metering device with a pressure control valve in accordance with one embodiment of the invention;

FIG. 2 is a schematic view of the water flow metering device of FIG. 1 coupled with a timer and shutoff valve;

FIG. 3 is a schematic view of a water flow metering device with a pressure transducer in accordance with another embodiment of the invention;

FIG. 3A is a cross sectional view of a pressure transducer in accordance with an embodiment of the invention;

FIG. 4A is a schematic diagram of a water distribution system in accordance with the present invention;

FIG. 4B is a data table associated with a water distribution system controller;

FIG. 5 is a schematic view of another embodiment of a water flow metering device used in conjunction with a gear drive sprinkler;

FIG. 5A is a front view of the label on the gear drive sprinkler of FIG. 5;

FIG. 5B is a partial front view of alternate indicia for the brackets of the device of FIG. 5;

FIG. 6A is a schematic diagram of a water distribution system in accordance with the present invention;

FIG. 6B is a data table associated with a water distribution system controller;

FIG. 7 is a schematic view of another embodiment of a water flow metering device used in conjunction with an impulse head sprinkler;

FIG. 7A is a front view of the label on the impulse head sprinkler of FIG. 7;

FIG. 8 is a schematic view of another embodiment of a water flow metering device used in conjunction with an oscillating sprinkler;

FIG. 8A is a front view of the gearbox label of the oscillating sprinkler of FIG. 8;

FIG. 8B is a front view of the label on the oscillating sprinkler of FIG. 8;

FIG. 9 is a schematic view of another embodiment of a water flow metering device used in conjunction with a whirling sprinkler;

FIG. 10 is a schematic view of another embodiment of a water flow metering device used in conjunction with a water pistol;

FIG. 10A is a front view of the label on the nozzle of the water pistol of FIG. 10;

FIG. 11 is a top view of a lawn using a sprinkler with a water flow metering device in accordance with another embodiment of the present invention;

FIG. 11A is a perspective view of the water flow metering device of FIG. 11;

FIG. 11B is a perspective partially disassembled view of the water flow metering device of FIG. 11A;

FIG. 11C is a partial top view of the sprinkler of FIG. 11; and

FIG. 12 is a schematic view of a device for measuring water flow and identifying depth over time information in accordance with another embodiment of the present invention.

FIG. 13 is a schematic plan view of a water management control device in accordance with another embodiment of the present invention and operating in a time mode.

FIG. 14 is a schematic plan view showing the water management control device of FIG. 13 operating in a depth mode.

FIG. 15 is a schematic view showing a computer system for implementing the water management control device of FIG. 13.

FIG. 16 is a partially disassembled view showing the water management control device of FIG. 13 and a switch device within the body thereof.

FIGS. 17-20 are views showing a water flow metering device in accordance with another embodiment of the present invention and including a view window for revealing an iconographic indicia contained on an indicia plate.

FIG. 21-23 are views showing a water flow metering device in accordance with another embodiment of the present invention and including a view window for revealing an iconographic indicia contained on an indicia plate.

### DETAILED DESCRIPTION

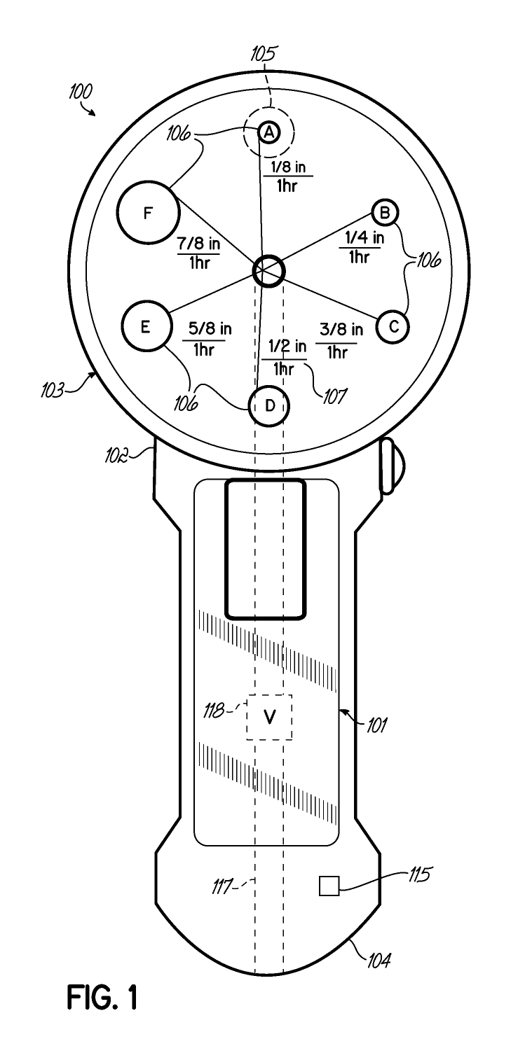

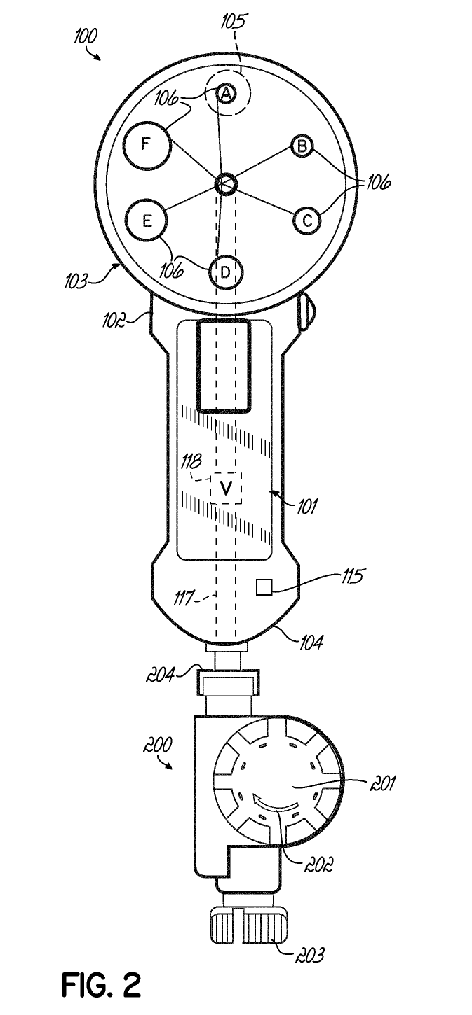

The figures demonstrate multiple embodiments of a water flow metering device for managing amounts of water discharged, or sprayed, from a sprinkler. In FIGS. 1 and 2, one embodiment of the water flow metering device 100 consists of a wand-style sprinkler having a device body 101, a water distribution head 102, a pressure control valve 118, and a flow pattern selector 103. The device body 101 includes a water inlet 104 and an internal passage 117. The internal passage 117 is in fluid communication with the water distribution head 102, which includes a discharge orifice 105 directed upward out of the page in FIGS. 1 and 2. The pressure control valve is disposed within the internal passage 117 between the water inlet 104 and the water distribution head 102, and the pressure control valve 118 limits the pressure of water entering the water flow metering device 100 to a predetermined pressure. In some embodiments, the pressure control valve 118 may be an elongate orifice that forces any incoming water pressure within a normal residential range of 40-100 psi to a predetermined pressure of approximately 40 psi. Another example of a pressure control valve 118 may be found in the disclosure of U.S. Pat. No. 2,053,931 to Work, the disclosure of which is hereby incorporated by reference in its entirety, although other designs of a pressure control valve 118 are possible. The pressure control valve 118 may also be positively closed in some embodiments to stop supply of water to the water distribution head 102. The flow pattern selector 103 is a rotatable dial including a plurality of flow outlets 106 configured to rotate into communication with the discharge orifice 105. Although the flow pattern selector dial 103 may include any number of flow outlets 106 of different shapes and sizes, the illustrated dial 103 includes six: A, B, C, D, E and F.

Each flow outlet 106 is configured to allow a different amount of water to pass through the selector dial 103. The selector dial 103 also includes a label 107 providing indicia showing the amount of water discharged by the water flow metering device 100 when a particular flow outlet 106 has been selected. The amount of water discharged is calculated based on the predetermined pressure delivered through the pressure control valve 118 and the size of the respective flow outlet 106. Although various volume measurement standards can be used on the label 107 to indicate the amount of water discharged, in the present embodiment the discharge is measured in inches per hour, which is convenient for watering lawns with grass seed that requires a certain amount of watering measured in inches per week. As shown by the label 107 on the illustrated selector dial 103, flow outlet A meters water flow to spray at about a rate of ⅛ inches per hour. Flow outlet B meters water flow to spray at about a rate of ¼ inches per hour. Flow outlet C meters water flow to spray at about a rate of ⅜ inches per hour. Flow outlet D meters water flow to spray at about a rate of ½ inches per hour. Flow outlet E meters water flow to spray at about a rate of ⅝ inches per hour. Flow outlet F meters water flow to spray at about a rate of ⅞ inches per hour.

In use, the operator selects the flow outlet 106 corresponding to the volume flowrate of water desired to be discharged over an area. Using the label 107, the operator is able to determine the time period over which to leave the sprinkler activated, based on the flow outlet 106 selected, in order to achieve the desired depth of water discharged over an area. Therefore, a landowner can ensure that grass seed or fertilizer on a lawn receives adequate watering without wasting excess amounts of water.

In another embodiment, the pressure control valve 118 may be adjustable over a range of pressures. In this case, the water distribution head 102 may receive a plurality of selector dials each associated with a different water pressure setting. Alternatively, the label 107 may include a plurality of indicia associated with a plurality of different water pressure settings, such that the water flow rate selection may be made under different conditions.

In the illustrated embodiment shown in FIG. 2, the water flow metering device 100 may also be coupled with a timing mechanism 200. The timing mechanism 200 can be a timer shutoff valve 200 such as disclosed in U.S. Pat. No. 6,398,185 to Wang, for example, which patent and disclosure are incorporated by reference herein. The timer shutoff valve 200 includes a valve which normally closes off flow from a timer inlet 203 coupled to a water hose to a timer outlet 204 coupled to the water inlet 104 of the water flow metering device 100. When a timer 201 is wound in a clockwise direction as indicated by arrow 202, the valve inside the timer shutoff valve 200 is opened and water is allowed to flow through the water flow metering device 100. Alternatively, the timing mechanism 200 may open and close the pressure control valve 118 previously described to permit the flow of water through the water flow metering device 100. A torsion spring drives an intermittent gear set to return the timer 201 back to the original position after a predetermined period of time as needed by the operator. When the timer 201 is completely returned to the original position, the valve portion of the timer shutoff valve 200 is activated and the flow of water to the sprinkler is blocked again. Thus, the water flow metering device 100 and the timer shutoff valve 200 can be used in conjunction so that an operator can set an amount of watering to be done and then leave the area until it is convenient to return without risk of overwatering.

In one embodiment, the timing mechanism 200 may also include an accumulator device 115. The accumulator device 115 may be coupled to the device body 101 or molded into the device body 101 as a cavity for collecting ambient or natural rainfall in the area of the water flow metering device 100. The accumulator device 115 operates like a rain gauge and may include a sensor for detecting the amount of natural rainfall in inches per hour. Consequently, the accumulator device 115 may communicate with the timing mechanism 200 to permit the timing mechanism 200 to adjust the amount of watering done before the water supply is cut off from the water distribution head 102. Thus, the accumulator device 115 further prevents overwatering of the sprinkler area.

Alternatively, the accumulator device 115 may be incorporated on embodiments of the water flow metering device 100 without a timing mechanism 200. The accumulator device 115 is still coupled to the device body 101 or molded into the device body 101 as a cavity for collecting ambient or natural rainfall. A user may personally check the accumulator device 115 to determine what flow pattern and length of watering time need to be selected to provide optimum watering.

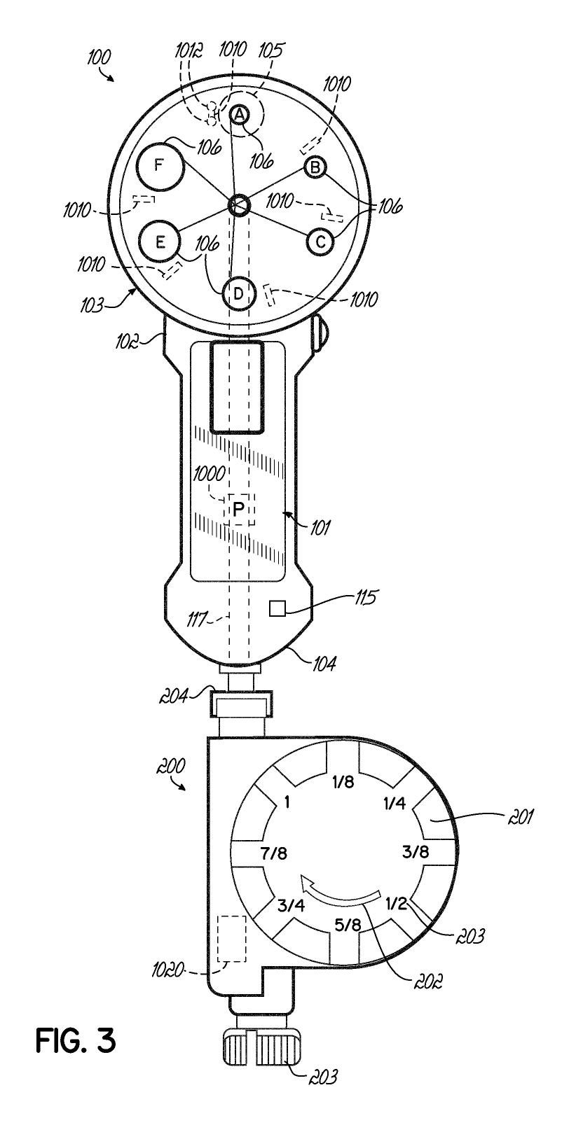

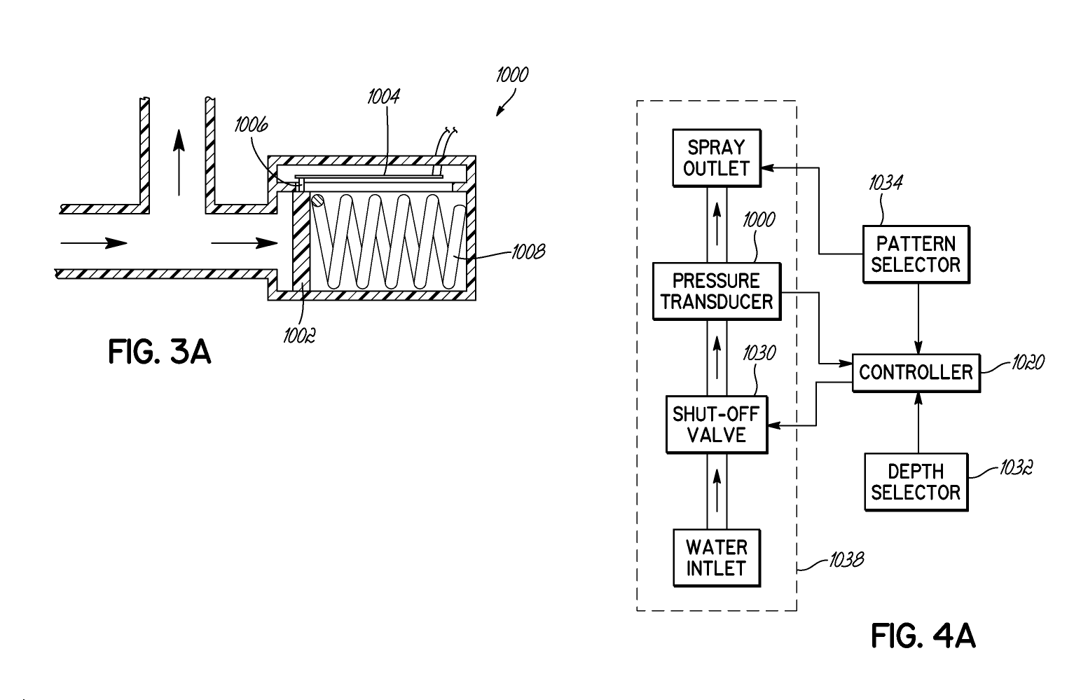

In the illustrated embodiment shown in FIG. 3, a flow water metering device 100 may include a pressure transducer 1000 rather than a pressure control valve as earlier described. The pressure transducer 1000 may be disposed within the internal passage 117 of the device housing 101. A controller 1020, electrically connected to other components as further described, is housed within the timing mechanism 200.

As shown in more detail in FIG. 3A, the pressure transducer 1000 includes a spring-biased stage 1002 that is configured to have a strip of electrically resistant material 1004 along the length of its travel. A pick-up 1006 attached to the stage 1002 interfaces with this material 1004 and forms an electrical circuit which communicates with the controller 1020. Depending on the position along the strip of material 1004 at which the pick-up 1006 interfaces, the circuit will have a different resistance value. This resistance can be used to determine the position of the stage 1002 by measuring the resistance of the circuit. The pressure of the water pushes on the stage 1002 and forces it back until a spring 1008 that provides a biasing force on the stage 1002 reaches equilibrium with the incoming water pressure. Measuring the resistance in the circuit therefore measures the pressure in the water flow.

As shown in FIG. 3, the water flow metering device 100 may also include a series of electrically resistant strips 1010, each associated with one of the six flow outlets 106 (A-F) on the selector dial 103. A pick-up 1012 near the discharge orifice 105 is positioned to connect to the strip 1010 associated with a given flow outlet when that outlet is mated to the orifice 105 as described above, forming a circuit that communicates electrically with the controller 1020. Each of the electrically resistant strips 1010 has a different resistance value. When a circuit is formed between any strip 1010 and the pick-up 1012, measuring the resistance in the circuit indicates which flow outlet 106 is selected for use.

In this embodiment the timer 201 includes indicia 203 which allow a user to select a total depth of water to be distributed by the device 100. The timer 201 is also in electrical communication with the controller 1020.

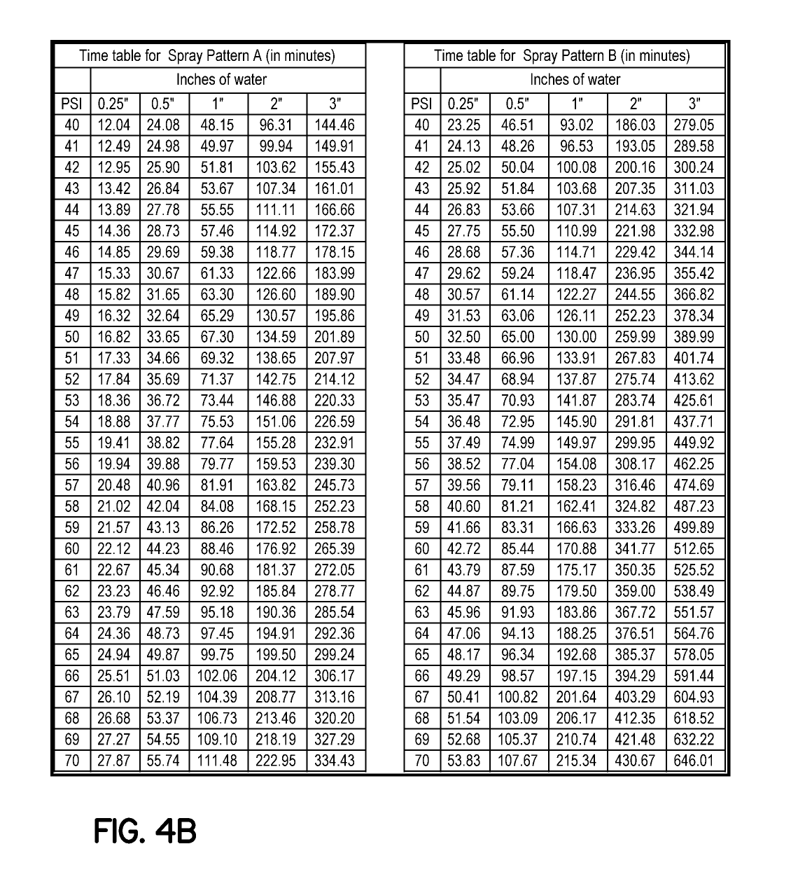

FIG. 4A illustrates the connections between the controller 1020 and other components. The pressure transducer 1000 and a shut-off valve 1030 are disposed within the flow path 1038 between the water inlet 104 and spray outlet 106. The pressure transducer 1000 and shut-off valve 1030 are each in electrical communication with the controller 1020. The shut-off valve 1030 may be part of the timer device 200 as earlier described, or may be another valve component as further described below. A pattern selector 1034 provides a user interface by which to choose a plurality of spray patterns; the pattern selector 1034 may be physically or electronically mated to the spray outlet and communicates with the controller 1020. The pattern selector 1034 may be the selector dial 103 as described above with pick-ups 1012 forming the connection to the controller 1020, or may be any of the flow selection devices described further below. The depth selector 1032, which may be the timer dial 201 described above, is the device by which a user selects a depth of water to be distributed through the spray device 100, and may be any of a number of different user interfaces including those further described below.

The controller 1020 receives input from the pattern selector 1034 indicating the selected spray pattern and input from the pressure transducer 1000 indicating the measured volumetric flow of the water, from which the controller 1020 determines a depth-per-time value for the water flowing through the device. When a desired distribution depth is input from the depth selector 1032, the controller uses the depth per time to further determine how long the device should run in order to distribute the desired depth of water. After the calculated amount of time has elapsed, the controller 1020 activates the shut-off valve 1030 to shut off the water flow to the device 100 and prevent further distribution of water, thus limiting the water distribution to the amount selected by the user.

The controller 1020 may determine the amount of time to run the water metering device 100 in a variety of ways. In one embodiment, memory associated with the controller 1020 may include data that matches water pressure within a given range to a set of time values associated with each available depth selection. A separate data table may exist for each spray pattern selection. Where some of the data displayed comes from an analog source, the data tables could reflect a range of values. Example tables for two spray patterns are shown as FIG. 4B.

In addition to this indexing system, the controller 1020 could instead use a variety of calculations to determine the correct time. For example, the value from the pressure transducer 1000 could be used to generate a volume per unit time value V/t, and the value from the pattern selector 1034 could be used to produce an area value A. Each of V/t and A may be calculable from known geometric and flow equations or determined empirically, and may be produced by functions called by the controller, by the use of simplified look-up tables, or otherwise determined by the controller as known in the art. If the user inputs a desired distribution depth d, the equation that determines the distribution of water would be:

d=[(V/t)/A]*t (1)

Which means that the amount of time that the device needs to run with the established configuration is:

t=d*A/(V/t) (2)

The controller 1020 could be easily configured to allow the device 100 to run for the calculated value of time t generated by the above equation.

One of ordinary skill will understand that in some situations, the water flow may vary significantly over the course of the water distribution process. In another embodiment of a water distribution system, the controller 1020 may evaluate the volumetric flow of water at set intervals, for example once per second, and may use formula (1) above to calculate the depth of water distributed over the set interval assuming one unit of time running at the measured geometric flow. The controller 1020 keeps a counter of the total depth of water distributed and adds the new calculated water depth to the previous total, then checks the new total against the user-entered depth goal to determine whether to activate the shut-off valve 1030 to shut off the water. This updating evaluation by the controller may produce more accurate water distribution in response to variable pressure conditions. If the accumulator device 115 is also connected to the controller 1020, natural rainfall can be added to the distributed water total to further reduce runtime and prevent over-watering.

One of ordinary skill in the art will recognize other advantageous embodiments that lie within the scope of this invention, some of which are outlined below. As one example, the pressure transducer 1000 may be replaced by any device that can measure the volumetric flow of the water with sufficient accuracy for the controller 1020 to make a depth of distribution calculation. In another embodiment, the pressure transducer 1000 could be an optical encoder as known in the art, a rotor associated with the encoder being disposed within the flow of water in order to allow for measurement of the velocity of the water. Any device which allows the controller to determine the volumetric flow of water would be sufficient to carry out the invention as herein described.

In another embodiment, an adjustable pressure control valve may be used in place of a pressure transducer, the pressure control valve communicating with the controller 1020 to convey the user-selected pressure setting to the controller 1020 for accurate timing calculations as described above.

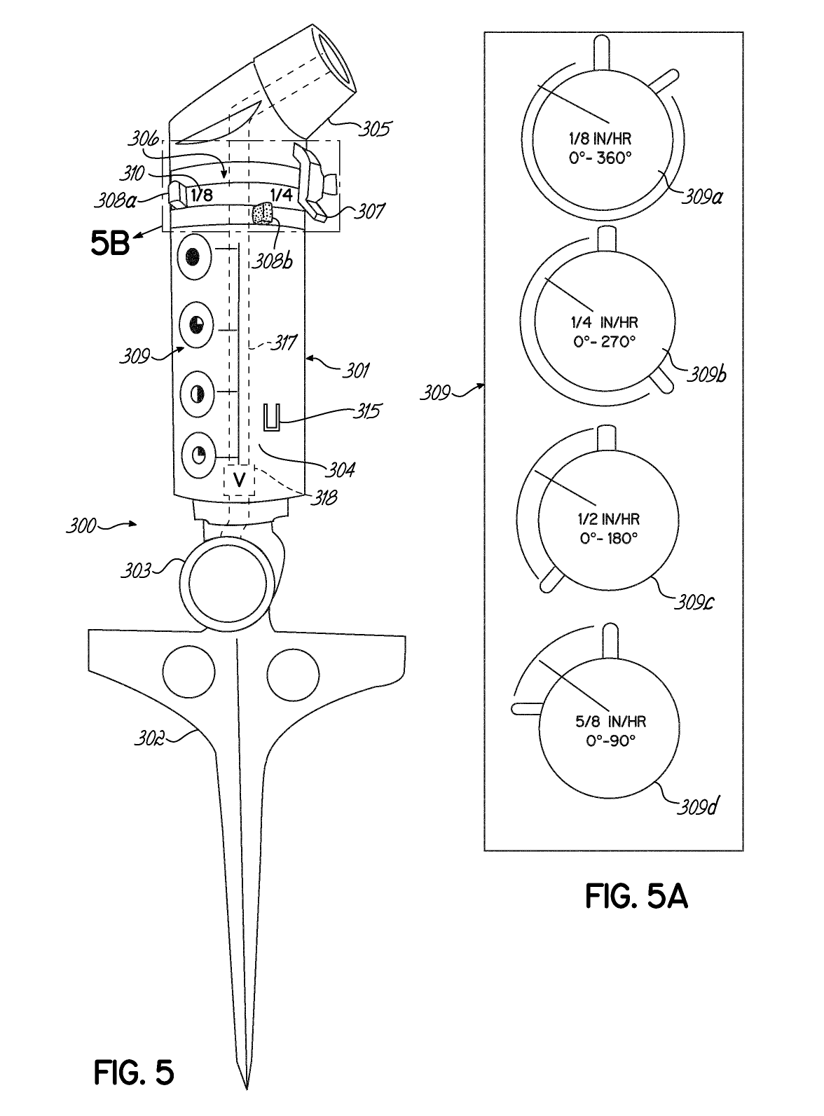

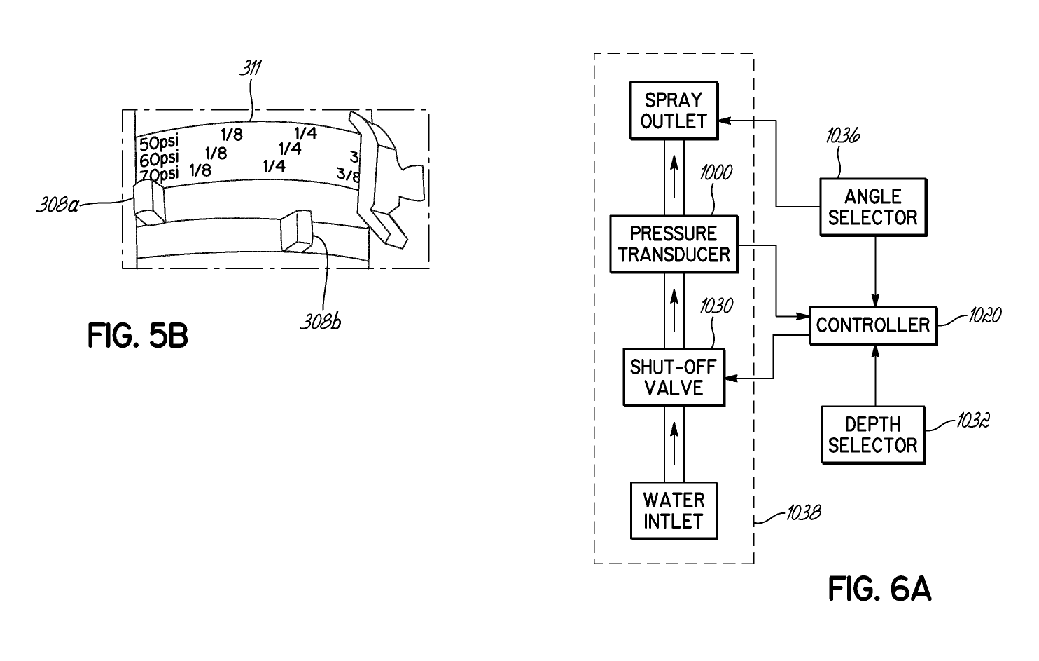

FIGS. 5-8B illustrate additional embodiments of a water flow metering device, indicated by the numerals 300, 400, 500, in use on various types of angle-control multi-pattern sprinklers. In one of these alternative embodiments, shown in FIGS. 5 and 5A, a water flow metering device 300 is incorporated in a gear drive sprinkler having a device body 301. The device body 301 includes a spike 302 for being driven into the ground, a water inlet 303 for coupling to a water hose, and a main body portion 304 having an internal flow passage 317 leading to a discharge head 305. A pressure control valve 318 is disposed within the internal flow passage 317 between the water inlet 303 and the discharge head 305, and the pressure control valve 318 limits the pressure of water entering the water flow metering device 300 to a predetermined pressure. Internal gearing drives the discharge head 305 to rotate and spray in an arc. The length of the spray arc can be modified by the flow pattern selector 306 of this embodiment, which is a tab 307 secured to the discharge head 305 and a pair of brackets 308a, 308b secured to the main body portion 304. The operator positions the brackets 308a, 308b to allow the discharge head 305 to oscillate for a desired arc length or range. The force generated by the rotation of the discharge head 305 pushes the tab 307 against one of the brackets 308a, 308b. The force of the tab 307 against the bracket 308a, 308b causes the tab 307 to shift the set of gears inside the gear drive, causing the discharge head 305 to begin rotation in the opposite direction.

The main body portion 304 includes a label 309 illustrating different degrees of rotation set by moving the brackets 308 to the illustrated positions. As shown in FIG. 5A, the label 309 also provides indications of how many inches per hour of water will be delivered by the water flow metering device 300 in the illustrated positions. Thus, for a full 360 degrees of rotation, the water flow metering device 300 will spray the area with ⅛ inches per hour (309a). For 270 degrees of rotation, the water flow metering device 300 will spray the area with ¼ inches per hour (309b). For 180 degrees of rotation, the water flow metering device 300 will spray the area with ½ inches per hour (309c). For 90 degrees of rotation, the water flow metering device 300 will spray the area with ⅝ inches per hour (309d). The brackets 308 may also be used in conjunction with another set of indicia 310 in order to convey the depth per hour information as well. The indicia 310 are placed on the ring associated with one bracket 308a as shown, such that the other bracket 308b is positioned directly below a depth per hour rate associated with the angle formed between the two brackets. The bracket 308b may be the color of the indicia 310 in order to make the displayed information more intuitive; alternatively, an arrow or other marking on the bracket 308b may direct the user's attention to the depth rate distribution information shown.

In use, the operator uses the brackets 308 to select a range for the discharge head 305 to oscillate based on the size of the area the operator wishes to water, and leaves the device 300 active for the amount of time necessary to achieve the desired depth of water. The water flow metering device 300 may also be combined with a timer mechanism 200 and/or an accumulator device 315 as previously described.

In another embodiment, shown in FIG. 5B, the pressure control valve 318 may be adjustable over a range of pressure values, and an indicia ring 311 proximate the brackets 308a, 308b may include multiple sets of indicia to allow for multiple pressure settings as shown. The indicia ring 311 may be independently rotatable to align its “zero” mark with the upper bracket 308a, the alignment of the lower bracket 308b with the proper segment of the ring conveying the flow rate information for the given angle setting.

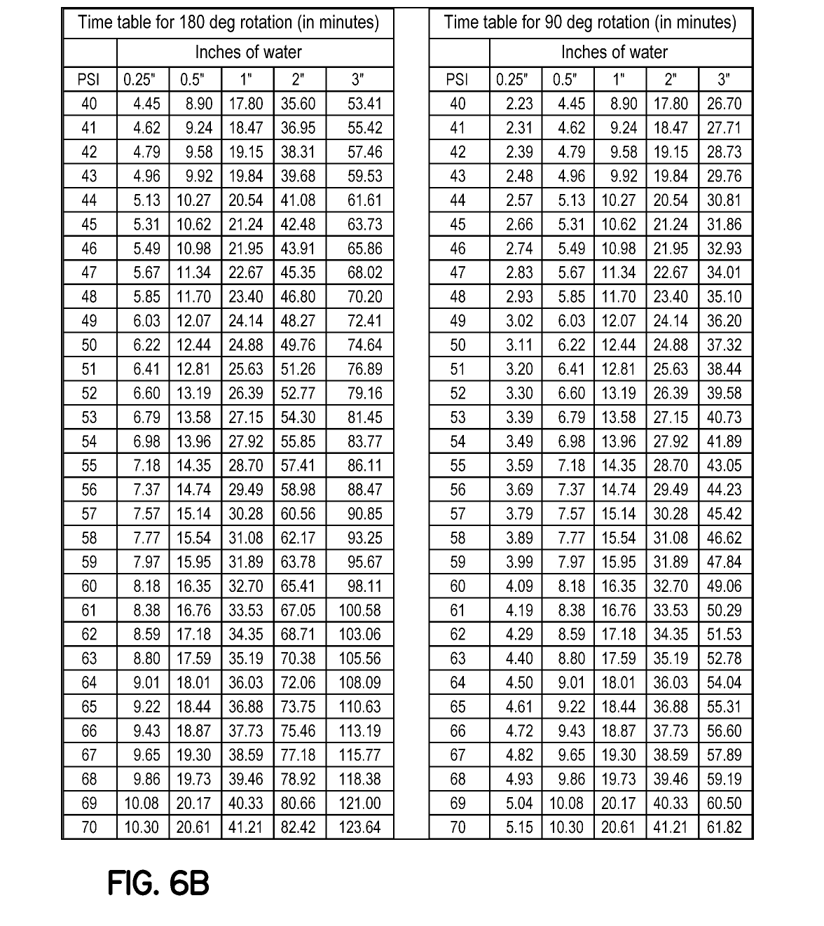

As described above with respect to the device 100, the device 300 may also include a pressure transducer or other volumetric flow measurement device in place of the pressure control valve 318, and include an associated controller 1020 as illustrated in FIG. 6A. The brackets 308a, 308b, acting as the angle selector 1036, may be electrically connected to the controller 1020 and act as a pattern selector 1034. FIG. 6B is an example of one set of tables that may be appropriate for use with a controller 1020 and the device 300.

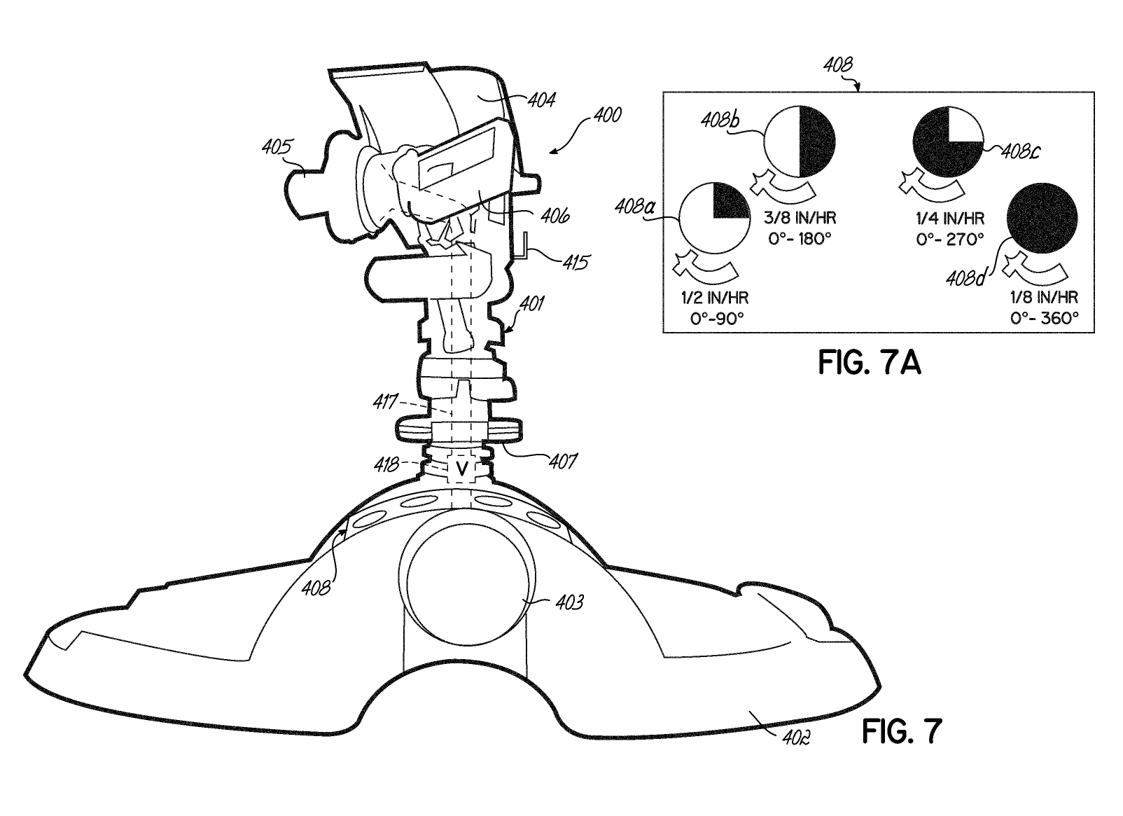

In another embodiment of the water flow metering device 400 provided in FIGS. 7 and 7A, the flow metering device is incorporated in an impulse or impact head sprinkler having a device body 401. The device body 401 has a base 402 with a water inlet 403 and a discharge head 404 with a flow outlet 405 and a spring-loaded arm 406. A pressure control valve 418 is disposed in an internal passage 417 between the water inlet 403 and the discharge head 404, and the pressure control valve 418 limits the pressure of water entering the water flow metering device 400 to a predetermined pressure. The water flow metering device 400 further includes a flow pattern selector 407 which in the illustrated embodiment is a member 407 that limits the rotational arc of the device body 401. The water exits the flow outlet 405 and impacts the spring-loaded arm 406, which recoils and causes the device body 401 to rotate before returning to impact the flow again.

The base 402 includes a label 408 which shows the amount of water flow the water flow metering device 400 will deliver at different settings of the flow pattern selector 407. In the illustrated label 408 of FIG. 4A, for a full 360 degrees of rotation, the water flow metering device 400 will spray the area with ⅛ inches per hour (408d). For 270 degrees of rotation, the water flow metering device 400 will spray the area with ¼ inches per hour (408c). For 180 degrees of rotation, the water flow metering device 400 will spray the area with ⅜ inches per hour (408b). For 90 degrees of rotation, the water flow metering device 400 will spray the area with ½ inches per hour (408a). In use, the operator uses the flow pattern selector 407 to select an arc for the discharge head 404 to oscillate through based on the size of the area the operator wishes to water, and leaves the device 400 active for the amount of time necessary to achieve the desired depth of water. Indicia may be added proximate the flow pattern selector 407, to indicate water depth for a given setting.

The water flow metering device 400 may also be combined with a timer mechanism 200 and/or an accumulator device 415 in a manner consistent with what was previously described. A pressure transducer 1000 or other volumetric flow measurement device may be used instead of the pressure control valve 418, with the flow pattern selector 407 acting as the angle selector 1036 in carrying out the water control process described above and the system configuration illustrated in FIG. 6A, the controller 1020 and depth selector 1032 being integrated into the device 400 as previously described.

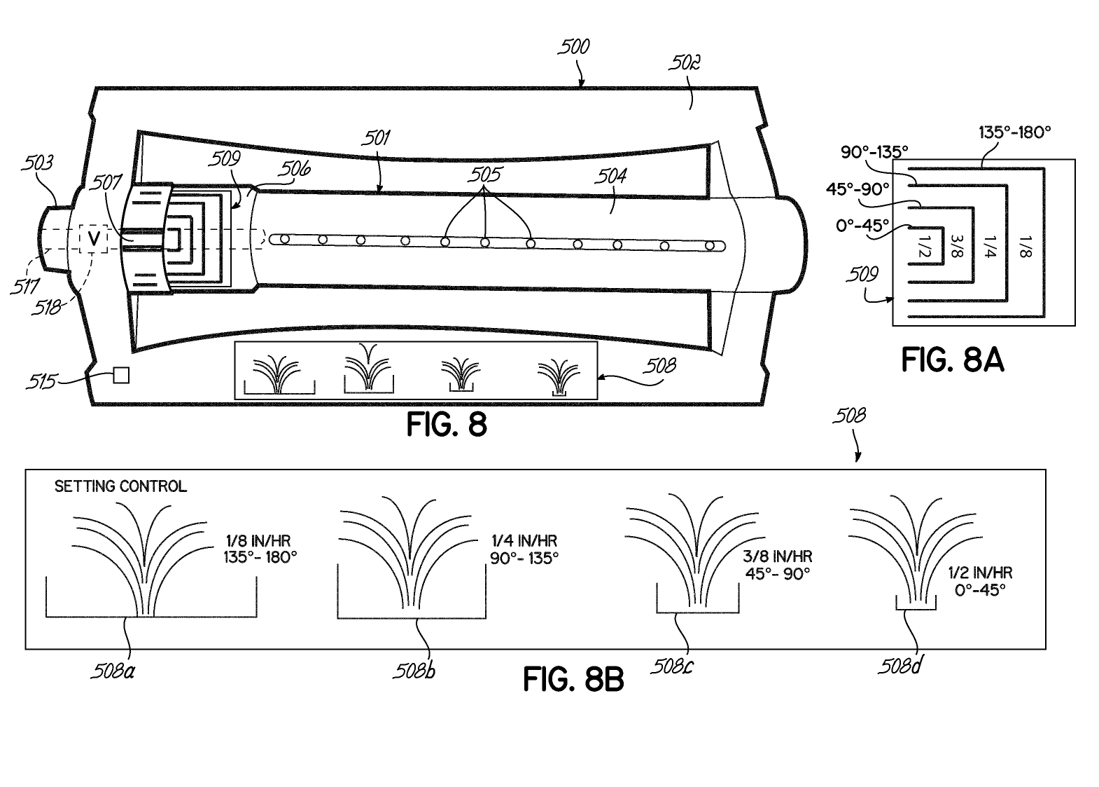

In another embodiment of the water flow metering device 500 provided in FIGS. 8, 8A, and 8B, the flow metering device is incorporated in an elongate oscillating sprinkler having a device body 501. The device body 501 has a base 502 with a water inlet 503 and a discharge tube 504 with a row of flow outlets 505 driven by water flowing through a gearbox 506. A pressure control valve 518 is disposed in an internal passage 517 between the water inlet 503 and the discharge tube 504, and the pressure control valve 518 limits the pressure of water entering the water flow metering device 500 to a predetermined pressure. The water flow metering device 500 further includes a flow pattern selector 507 which in the illustrated embodiment is a switch 507 that limits the rotational arc of the discharge tube 504. The water exits the flow outlets 505 as the discharge tube 504 cycles through arcs of the set amount of degrees. The pressure control valve 518 cooperates with the predetermined outlets 505 for any given user selected pattern to yield the water depth per hour or a range of depth per hour on sprinkler devices where the flow pattern selector is a pair of limiting brackets that limit the rotation of the sprinkler head.

The base 502 includes a label 508 which shows the amount of water flow the metering device 500 will deliver at different settings of the flow pattern selector 507. The water flow metering device 500 may also include a gearbox label 509 as illustrated in FIG. 8A to show the various settings of the flow pattern selector 507. In the illustrated label 508 shown in FIG. 8B, for a 135-180 degrees of rotation, the water flow metering device 500 will spray the area with ⅛ inches per hour (508a). For 90-135 degrees of rotation, the water flow metering device 500 will spray the area with ¼ inches per hour (508b). For 45-90 degrees of rotation, the water flow metering device 500 will spray the area with ⅜ inches per hour (508c). For 0-45 degrees of rotation, the water flow metering device 500 will spray the area with ½ inches per hour (508d). In use, the operator uses the flow pattern selector 507 to select an arc for the discharge tube 504 to oscillate through based on the size of the area the operator wishes to water, and leaves the device 500 active for the amount of time necessary to achieve the desired depth of water.

The water flow metering device 500 may also be combined with a timer mechanism 200 and/or an accumulator device 515 in a manner consistent with what was previously described. A pressure transducer 1000 or other volumetric flow measurement device may be used instead of the pressure control valve 518, with the flow pattern selector switch 507 acting as the angle selector 1036 in carrying out the water control process described above and the system configuration illustrated in FIG. 6A, the controller 1020 and depth selector 1032 being integrated into the device 500 as previously described.

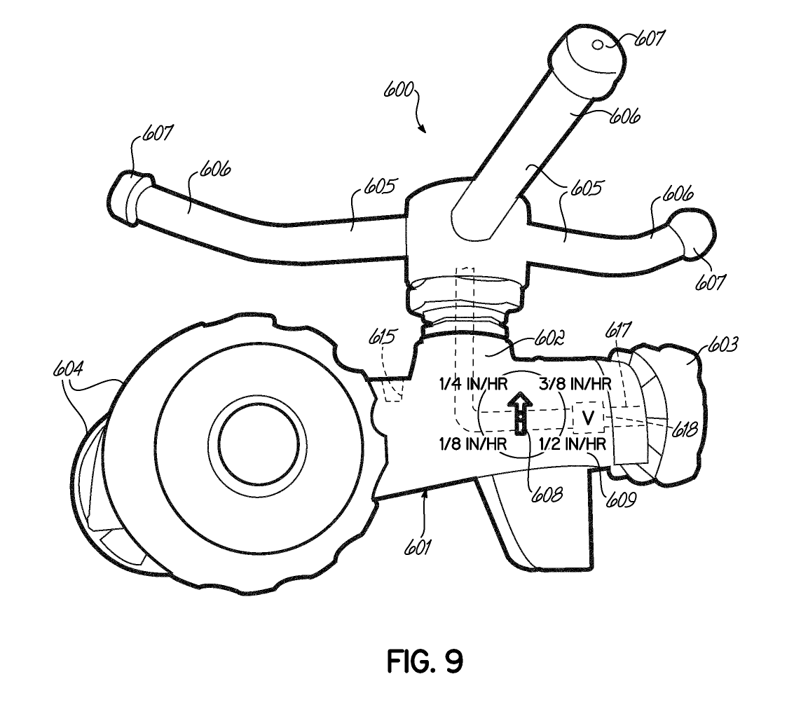

In another embodiment of the water flow metering device 600 provided in FIG. 9, the flow metering device is incorporated in a single-pattern sprinkler such as a whirling sprinkler having a device body 601. The device body 601 has a base 602 with a water inlet 603 and wheels 604 for moving the device body 601. The water inlet 603 is in fluid communication with three discharge arms 605 having angled ends 606 with flow outlets 607. As water travels through the discharge arms 605, the movement of the water through the angled ends 606 automatically drives rotation of the three discharge arms 605 to cover a full 360 degrees of spray. A pressure control valve 618 is disposed in an internal passage 617 between the water inlet 603 and the discharge arms 605, and the pressure control valve 618 limits the pressure of water entering the water flow metering device 600 to a predetermined pressure.

In some embodiments, the water flow metering device 600 further includes a flow selector 608 which in the illustrated embodiment is a switch 608 that limits the flow of water through the device body 601. The switch 608 may control the pressure control valve 618 or may alternatively control a separate valve within the device body 601 to limit the flow of water through the device body 601. In other embodiments, the water flow metering device 600 does not include the flow selector 608. The flow selector 608 may include a label 609 indicating the amount of water flow the water flow metering device 600 will deliver at different settings of the flow selector 608. In embodiments of the water flow metering device 600 without a flow selector 608, a label 609 will still be provided on the water flow metering device 600 to indicate the amount of water depth per hour delivered by the water flow metering device 600 according to the size of the flow outlets 607 and the incoming pressure set by the pressure control valve 618.

The water flow metering device 600 may also be combined with a timer mechanism 200 and/or an accumulator device 615 in a manner consistent with what was previously described. A pressure transducer 1000 or other volumetric flow measurement device may be used instead of the pressure control valve 618, with the flow selector 608 acting as the pattern selector 1034 in carrying out the water control process described above and the system configuration illustrated in FIG. 4A, the controller 1020 and depth selector 1032 being integrated into the device 600 as previously described.

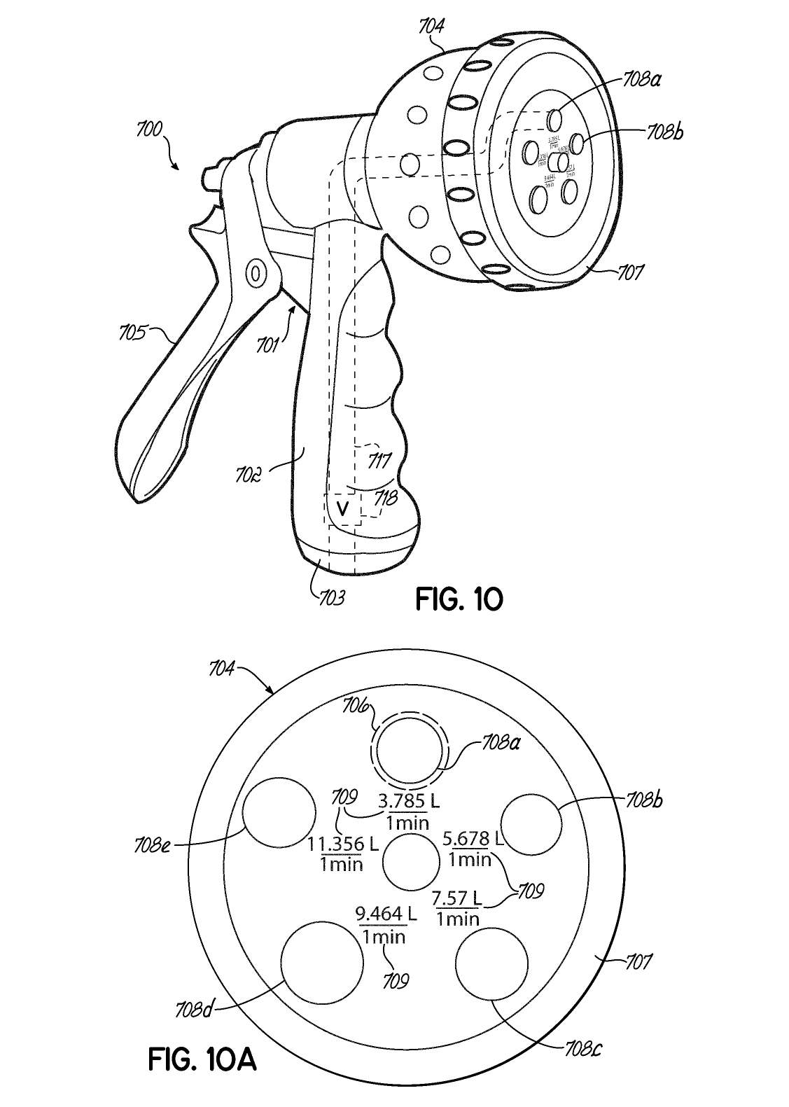

In another embodiment of the water flow metering device 700 provided in FIGS. 10 and 10A, the flow metering device is in the form of a water pistol having a device body 701. The device body 701 has a handle 702 with a water inlet 703 and a discharge head 704 coupled to the handle 702 opposite the water inlet 703. A pressure control valve 718 is disposed in an internal passage 717 between the water inlet 703 and the discharge head 704, and the pressure control valve 718 limits the pressure of water entering the water flow metering device 700 to a predetermined pressure. The device body 701 also includes a trigger 705 which may be compressed against the handle 702 to open the pressure control valve. The discharge head 704 includes a flow orifice 706 and a flow pattern selector 707 which in the illustrated embodiment is a dial 707 with a plurality of flow outlets 708. The flow outlets 708 may be rotated into fluid communication with the flow orifice 706 to provide varying metered levels of flow from the water flow metering device 700.

The dial 707 includes a label 709 (FIG. 10A) which shows the amount of water flow the water flow metering device 700 will deliver at different settings of the flow pattern selector 707. Unlike the previous embodiments, the label 709 shows flow rate amounts in liters per minute, which is useful for comparing the output of water of the water flow metering device 700 to the output of alternative watering devices such as watering cans. As shown by the label 709 on the illustrated dial 707, flow outlet 708a meters water flow to discharge at about a rate of 3.785 liters per minute. Flow outlet 708b meters water flow to spray at about a rate of 5.678 liters per minute. Flow outlet 708c meters water flow to discharge at about a rate of 7.57 liters per minute. Flow outlet 708d meters water flow to spray at about a rate of 9.464 liters per minute. Flow outlet 708e meters water flow to discharge at about a rate of 11.356 liters per minute. If an adjustable pressure control valve is used, the label may include multiple values to reflect different flow rates for different pressures, or the indicia may be replaceable to accommodate different pressure settings.

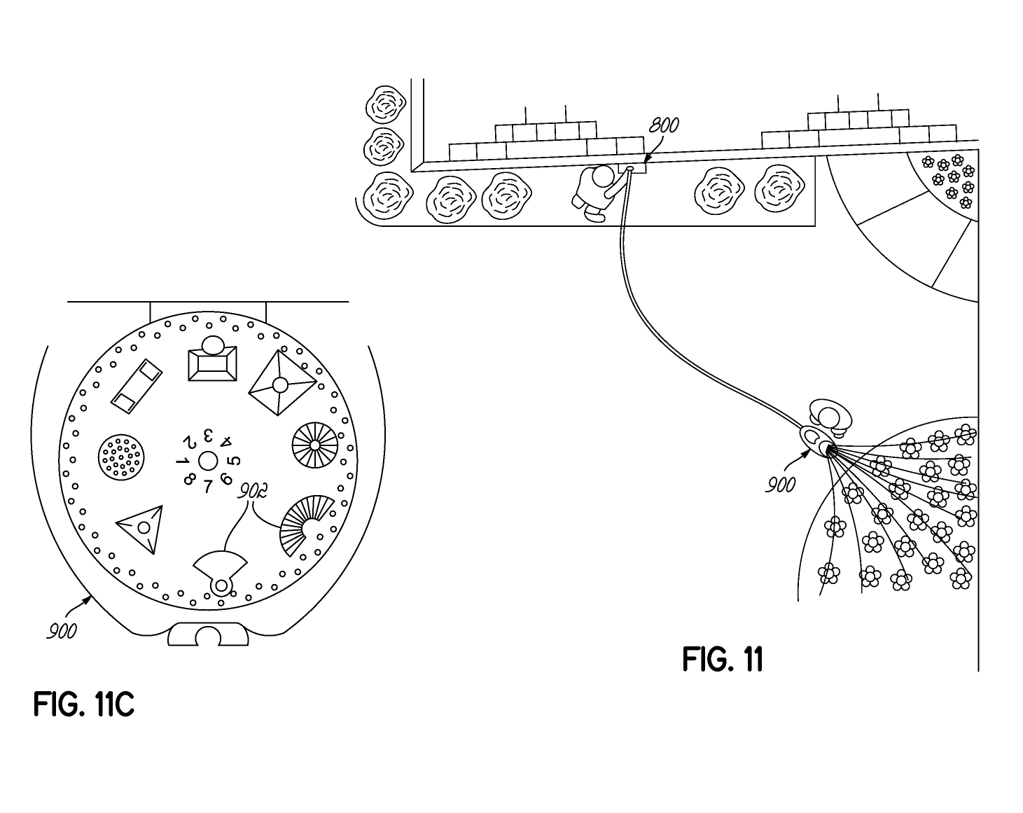

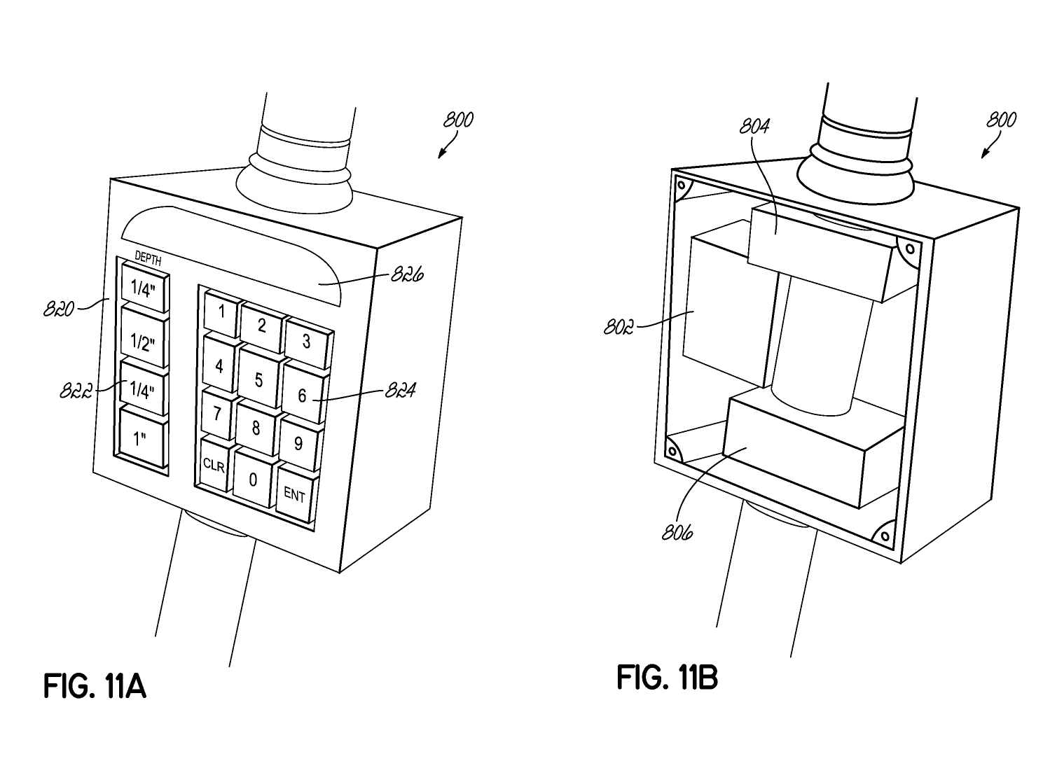

As shown in FIGS. 11-11C, a flow meter device 800 may also be disposed distant from a spray device 900. The spray device 900 may be any of the devices above or any other spray or sprinkler device for distributing water over an area, and may features for adjusting between a plurality of spray patterns as shown (FIG. 11C). The flow meter device includes an input panel 820, a controller 802, a volumetric flow measurement device 804, and a shut-off valve 806. The input panel 820, shown in FIG. 11A, includes a set of depth input buttons 822, a keypad 824, and a display 826.

The flow meter device 800 works generally according to the schematic illustrated as FIG. 4A. The controller 802 takes input in the form of a desired depth of water to be distributed from the depth input buttons 822. The keypad 824 acts as a flow selector, using numbered patterns as shown by the indicia 902 on the spray device 900 as shown in FIG. 11C. In one embodiment, the controller 802 communicates the selected pattern to the spray device 900 in order to determine the actual spray pattern in use.

In an alternative embodiment, the actual spray pattern is selected by another means on or near the spray device 900, and no electrical control between the meter device 800 and spray device 900 exists. In this alternative, the user may still input the chosen spray pattern into the keypad 824 in order to give the controller 802 data by which to calculate a run time for the water as described above. If this alternative is used, it will be recognized that many known flow geometries and sprinkler output configurations may be pre-programmed into the controller 802, such that a number of different sprinkler devices may be connected to the flow meter device 800. The specific device and device settings may then be input using the keypad 824, possibly with aid or confirmation from the display 826, in order to configure the controller to calculate depth times on the basis of the attached sprinkler head or heads.

In some cases, there may be multiple parameters to be considered. For example, a sprinkler head may have a plurality of nozzle geometries and also a variable angle of distribution, effectively giving the system both a pattern selector 1034 and an angle selector 1036 as described above. A controller 802 can accommodate a plurality of settings by means of the keypad 824 and display 826, prompting the user to input any settings information necessary to calculate the appropriate duration to run the device 900. Providing that the memory associated with the controller 802 is equipped with data or equations for calculating a run time based on the settings, any reasonable number of additional settings and parameters can be accommodated for by programming controller 802 in a manner known to one in the art.

In some embodiments, the controller 802 may be capable of storing sprinkler head settings for future watering events, such that the use of the depth input buttons 822 may be all that is necessary to meter additional water using the same settings as previously. If desired, a single button-press may be all that is necessary to reactivate the device.

In another embodiment, a pressure transducer or other volumetric measurement device may accompany a controller and display even in the absence of a timer or shut-off valve. Here the controller may use an ongoing signal representing the volumetric flow of water, as well as the known geometry of the water distribution pattern, in order to display a depth per unit time to the user. As in earlier embodiments discussed in the absence of a timer, a user desiring to distribute a set depth of water over an area can use the display to accurately plan the depth of water to distribute by any method known in the art.

The controller may receive input representing a variety of pattern configurations or parameters as known in the art and further described above, such as directly through communication with flow or angle selectors, or indirectly through the use of a keypad or other user input device, and may vary the depth per time display value in accordance with these different parameters as further described above. In one embodiment, an indicia ring mounted above or on angle-setting brackets, similar to those described above with respect to FIGS. 5 and 5B, may display a numerical code at different points along its circumference corresponding to different angle settings. The user could input the code most accurately reflecting the chosen bracket settings, allowing the controller to determine and display depth per time on the basis of the input settings. In one embodiment, numbers on the indicia could represent a coefficient that the controller multiplies or divides by to determine a depth per time, or any other numerical value used in a formula associated with the controller.

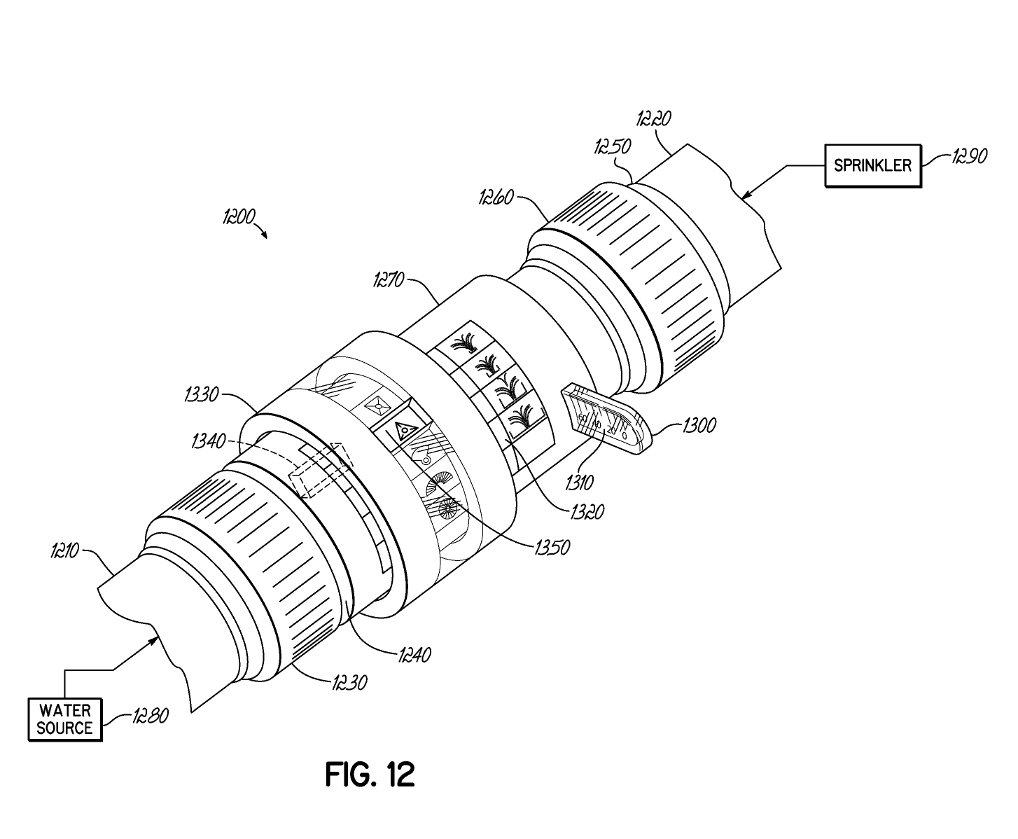

FIG. 12 illustrates a device 1200 configured to connect between two hose sections in order to measure the flow of water therethrough. As shown, the device 1200 is positioned between a first hose section 1210 and a second hose section 1220. The first hose section 1210 has an end connector 1230 that is connected to an inlet connector 1240 of the device 1200. The second hose section 1220 has an end connector 1250 that is connected to an outlet connector 1260 of the device 1200. End connectors 1230, 1250 and inlet/outlet connectors 1240, 1260 may be the type of connectors typically used in a water hose environment, such as corresponding male and female threaded connectors. The device 1200 has a generally cylindrical body 1270.

A passageway (not shown) extends through the device 1200 so that water can flow therethrough from the first hose section 1210 to the second hose section 1220. The first hose section 1210 is connected to a water source 1280 and the second hose section 1220 is connected to a sprinkler 1290 having a particular distribution pattern.

The device 1200 includes a pressure gauge 1300 for measuring the pressure of water flowing through it, and for providing an indication of the pressure value to a user, such as at 1310.

The device 1200 also includes an information chart 1320 that provides indicia relating to pressure values, sprinkler distribution patterns, and depth distribution of water over time information. Pressure values may be provided along the axial direction of the information chart 1320 (along the axis of flow of water). Sprinkler distribution patters and depth distribution of water over time information may be arranged circumferentially on the information chart 1320. A chart interpretation tool 1330 is provided and is moveable with respect to the information chart 1320. Particularly, the chart interpretation tool is rotatable around the device 1200 as well as being moveable along the axial direction thereof. The chart interpretation tool 1330 includes a first window 1340 and a second window 1350. A user positions the chart interpretation tool 1330 to an axial position on the information chart 1320 corresponding to the pressure value indicated at 1310 by the pressure gauge 1300. Maintaining the axial position, the user then positions the chart interpretation tool 1330 so the first window 1340 aligns with a distribution pattern corresponding to the distribution pattern of the sprinkler 1290 with which the device 1200 is used. The second window 1350, then, will reveal depth distribution of water over time information for the given pressure and distribution pattern. For example, a given pressure and distribution pattern may be associated with a depth distribution of water over time of one-half inch per hour.

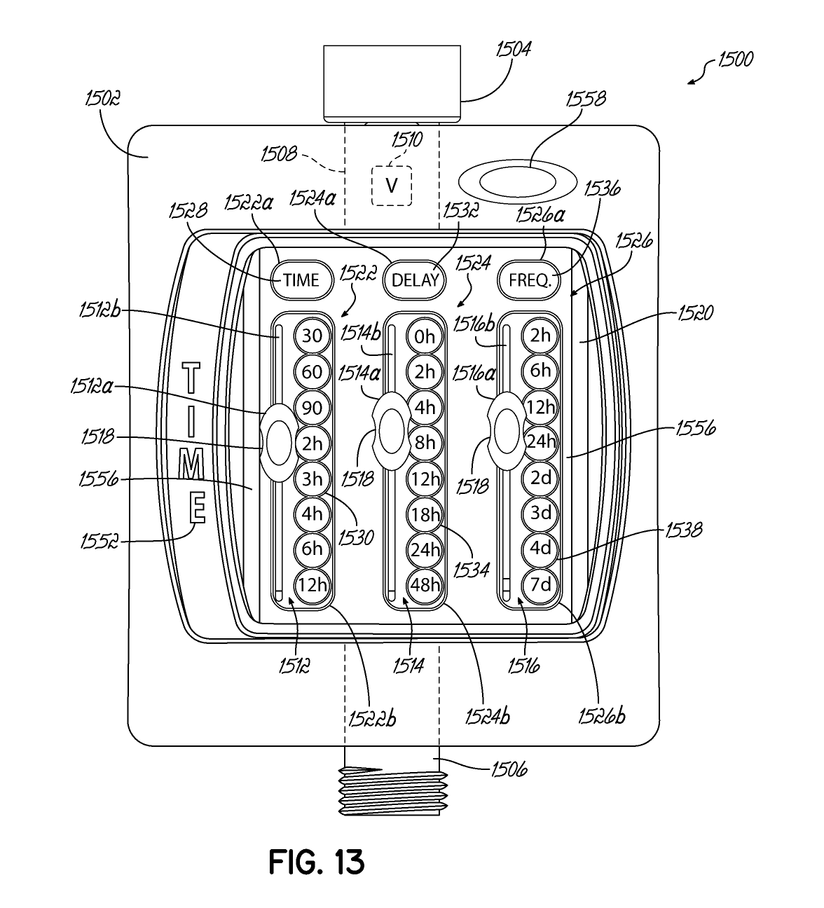

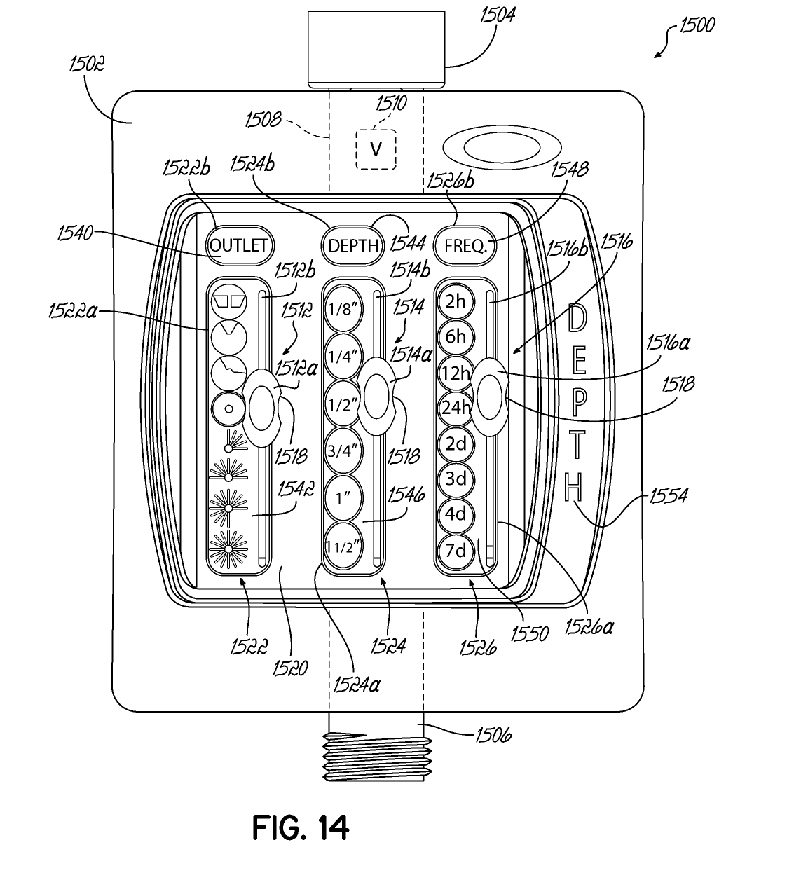

Referring next to FIGS. 13-16, a water management control device 1500 is shown. The water management control device 1500 is configured to operate in two modes, a time mode (FIG. 13) and a depth mode (FIG. 14), and to control the flow of water in those two modes based on inputs relating to watering by time and watering by depth from multiple input selectors, as will be explained.

The water management control device 1500 includes a body 1502 having an inlet 1504 and an outlet 1506. The inlet 1504 is configured to be coupled with a water source, such as a hose bib or faucet, or any other suitable water source. The outlet 1506 is configured to be coupled with a watering device, such as through an intermediate hose that is connected at one end to the outlet 1506 and at the other end to the water device. An internal passageway 1508 connects the inlet 1504 and the outlet 1506, and a valve 1510 regulates the flow of water through the internal passageway 1508. When the valve 1510 is in an open configuration, water can flow through the internal passageway 1508, and when the valve 1510 is in a closed configuration, water is prevented from flowing through the internal passageway 1508. The valve 1510 is configured to be opened and closed in the time mode and the depth mode in response to user-selected programming inputs.

The water management control device 1500 includes a plurality of input selectors for setting the user-selected programming inputs, including a first input selector 1512, a second input selector 1514, and a third input selector 1516. The input selectors 1512, 1514, 1516 are used to set inputs in both the time mode and the depth mode, and these inputs are used by the water management control device 1500 for controlling the valve 1510.

In the embodiment shown, the input selectors 1512, 1514, 1516 are slide selectors having knobs 1512a, 1514a, and 1516a, respectively, that are slidably moveable in selector slots 1512b, 1514b, and 1516b, respectively. Movement of the 1512a, 1514a, and 1516a to positions along the selector slots 1512b, 1514b, and 1516b allows a user to set input values, as will be explained. Advantageously, and as shown, the knobs 1512a, 1514a, and 1516a can each include contoured shapes, such as having cut-outs 1518, to facilitate manipulation of the knobs 1512a, 1514a, and 1516a for positioning along the slots 1512b, 1514b, and 1516b.

The water management control device 1500 is configured to present different information in association with the input selectors 1512, 1514, 1516 depending on whether the device 1500 is operating in the time mode or in the depth mode. To that end, the water management control device 1500 includes a blinder plate 1520 that is moveable between a first position that corresponds with operation in the time mode (FIG. 13) and a second position that corresponds with operation in the depth mode (FIG. 14). In the embodiment shown, the blinder plate 1520 is laterally moveable between the first and second positions.

The blinder plate 1520 includes a plurality of viewing windows that allow information beneath the binder plate 1520 to be observed when the viewing windows are aligned with the information. In particular, the blinder plate 1520 includes viewing windows 1522, 1524, and 1526. In the embodiment shown, each of the viewing windows 1522, 1524, and 1526 includes two subparts, with the subparts being designated as 1522a, 1522b, 1524a, 1524b, 1526a, and 1526b.

The viewing windows 1522, 1524, and 1526 are positioned on the blinder plate 1520 so as to be associated with the input selectors 1512, 1514, and 1516, respectively. In particular, the knobs 1512a, 1514a, 1516a and the selector slots 1512b, 1514b, 1516b are viewable through the window subparts 1522a, 1524a, and 1526a, in both the time mode and the depth mode, as shown in FIGS. 13 and 14.

The water management control device 1500 includes information beneath the blinder plate 1520 that relates to programming inputs associated with the input selectors 1512, 1514, and 1516 for both the time mode and the depth mode. In the embodiment shown, the programming inputs for the time mode include time, delay, and frequency, and for the depth mode include outlet pattern, depth, and frequency. Time inputs relate to how long the water management control device 1500 allows water to flow through it for a watering operation. Delay inputs relate to how long the water management control device 1500 waits before allowing water to flow through it for watering operations. Frequency inputs relate to how frequently the water management control device 1500 allows water to flow through it for watering operations. Outlet pattern inputs relate to the shape of the flow pattern used in an associated watering device for watering operations. Depth inputs relate to the depth of water deposited by an associated watering device over an area in watering operations.

For the time mode, and as shown in FIG. 13, the information beneath the blinder plate 1520 includes a time title 1528 and time values 1530 associated with the first input selector 1512. As shown in the figure, the time title 1528 and the time values 1530 are positioned generally to the right of the selector slot 1512b. When the blinder plate 1520 is in the first position, and when the device 1500 is operating in the time mode, the time title 1528 is viewable through the viewing window subpart 1522b and the time values 1530 are viewable through the viewing window subpart 1522a. The knob 1512a is moveable within the selector slot 1512b to select a time value input, as reflected on an adjacent portion of the time values 1530 information. For example, and as shown, the time values 1530 information provides time values ranging from 30 minutes to 12 hours, and the knob 1512a is positioned adjacent a time value of 2 hours. The time values displayed on the time values 1530 information are merely exemplary, however, and it will be appreciated that other time values could be included on the time values 1530 information, as appropriate for watering applications.

Also as shown in FIG. 13, the information beneath the blinder plate 1520 includes a delay title 1532 and delay values 1534 associated with the second input selector 1514. As shown in the figure, the delay title 1532 and the delay values 1534 are positioned generally to the right of the selector slot 1514b. When the blinder plate 1520 is in the first position, and when the device 1500 is operating in the time mode, the delay title 1532 is viewable through the viewing window subpart 1524b and the delay values 1534 are viewable through the viewing window subpart 1524a. The knob 1514a is moveable within the selector slot 1514b to select a delay value input, as reflected on an adjacent portion of the delay values 1534 information. For example, and as shown, the delay values 1534 information provides delay values ranging from 0 hours to 48 hours, and the knob 1514a is positioned generally between delay values of 4 hours and 8 hours. Like the time values, the delay values displayed on the delay values 1534 information are merely exemplary, however, and it will be appreciated that other delay values could be included on the delay values 1534 information, as appropriate for watering applications.

Also as shown in FIG. 13, the information beneath the blinder plate 1520 includes a frequency title 1536 and frequency values 1538 associated with the third input selector 1516. As shown in the figure, the frequency title 1536 and the frequency values 1538 are positioned generally to the right of the selector slot 1516b. When the blinder plate 1520 is in the first position, and when the device 1500 is operating in the time mode, the frequency title 1536 is viewable through the viewing window subpart 1526b and the frequency values 1538 are viewable through the viewing window subpart 1526a. The knob 1516a is moveable within the selector slot 1516b to select a frequency value input, as reflected on an adjacent portion of the frequency values 1538 information. For example, and as shown, the frequency values 1538 information provides frequency values ranging from 2 hours to 7 days, and the knob 1516a is positioned generally between frequency values of 12 hours and 24 hours. Like the other input values, the frequency values displayed on the frequency values 1538 information are merely exemplary, however, and it will be appreciated that other frequency values could be included on the frequency values 1538 information, as appropriate for watering applications.

For the depth mode, and as shown in FIG. 14, the information beneath the blinder plate 1520 includes an outlet pattern title 1540 and outlet pattern indicia 1542 associated with the first input selector 1512. As shown in the figure, the outlet pattern title 1540 and the outlet pattern indicia 1542 are positioned generally to the left of the selector slot 1512b. When the blinder plate 1520 is in the second position, and when the device 1500 is operating in the depth mode, the outlet pattern title 1540 is viewable through the viewing window subpart 1522b and the time values 1530 are viewable through the viewing window subpart 1522a. The knob 1512a is moveable within the selector slot 1512b to select an outlet pattern input, as reflected on an adjacent portion of the outlet pattern indicia 1542 information. For example, and as shown, the outlet pattern indicia 1542 information provides graphic indicia relating to the shapes of flow patterns created by the outlet of an associated watering device, and the knob 1512a is positioned adjacent one of the flow pattern graphic indicia. Advantageously, the associated watering device includes similar graphic indicia, such that a flow pattern setting selected on the watering device can also be selected on the water management control device 1500 based on the similar graphic indicia. In any event, a user could also refer to the graphic indicia provided by the outlet pattern indicia 1542 information and to the observed flow pattern created by the associated watering device in order to select an outlet pattern input on the first input selector 1512 approximating the flow pattern created by the associated watering device. The representations of flow patterns displayed on the outlet pattern indicia 1542 information are merely exemplary, however, and it will be appreciated that other flow patterns could be included on the outlet pattern indicia 1542 information, as appropriate for watering applications.

Also as shown in FIG. 14, the information beneath the blinder plate 1520 includes a depth title 1544 and depth values 1546 associated with the second input selector 1514. As shown in the figure, the depth title 1544 and the depth values 1546 are positioned generally to the left of the selector slot 1514b. When the blinder plate 1520 is in the second position, and when the device 1500 is operating in the depth mode, the depth title 1544 is viewable through the viewing window subpart 1524b and the depth values 1546 are viewable through the viewing window subpart 1524a. The knob 1514a is moveable within the selector slot 1514b to select a depth value input, as reflected on an adjacent portion of the depth values 1546 information. For example, and as shown, the depth values 1546 information provides depth values ranging from ⅛ of an inch to 1½ inches, and the knob 1514a is positioned generally adjacent a depth value of ½ inch. Like the other input values, the depth values displayed on the depth values 1546 information are merely exemplary, however, and it will be appreciated that other depth values or indicia relating to depth could be included on the depth values 1546 information, as appropriate for watering applications.

Also as shown in FIG. 14, the information beneath the blinder plate 1520 includes a frequency title 1548 and frequency values 1550 associated with the third input selector 1516. As shown in the figure, the frequency title 1548 and the frequency values 1550 are positioned generally to the left of the selector slot 1516b. When the blinder plate 1520 is in the second position, and when the device 1500 is operating in the depth mode, the frequency title 1548 is viewable through the viewing window subpart 1526b and the frequency values 1550 are viewable through the viewing window subpart 1526a. The knob 1516a is moveable within the selector slot 1516b to select a frequency value input, as reflected on an adjacent portion of the frequency values 1550 information. For example, and as shown, the frequency values 1550 information provides frequency values ranging from 2 hours to 7 days, and the knob 1516a is positioned generally between frequency values of 12 hours and 24 hours. Like the other input values, the frequency values displayed on the frequency values 1550 information are merely exemplary, however, and it will be appreciated that other frequency values could be included on the frequency values 1550 information, as appropriate for watering applications.

Advantageously, the information relating to the programming inputs for the time mode is only visible when the blinder plate 1520 is in the first position, and when the device 1500 is operating in the time mode. Also advantageously, the information relating to the programming inputs for the depth mode is only visible when the blinder plate 1520 is in the second position, and when the device 1500 is operating in the depth mode. The configuration of the blinder plate 1520, including the positioning and size of its viewing windows 1522, 1524, 1526, can be adjusted to control the information that is visible in both the time mode and the depth mode.

The water management control device 1500 can also include indicia for indicating to a user whether the device is operating in the time mode or the depth mode. As shown in FIG. 13, this includes a time mode label 1552 that is visible when the blinder plate 1520 is in the first position, and when the device 1500 is operating in the time mode. And as shown in FIG. 14, this also includes a depth mode label 1554 that is visible when the blinder plate 1520 is in the second position, and when the device 1500 is operating in the depth mode.

Advantageously, the blinder plate 1520 can include one or more grip regions 1556 that a user can manipulate to move the blinder plate 1520 between the first and second positions. The grip region 1556 can optionally include a raised edge, a knurled portion, or other feature for facilitating manipulation of the blinder plate 1520.

The programming inputs set using the input selectors 1512, 1514, 1516 are used by the water management control device 1500 to create a program sequence for controlling the operation of the valve 1510. In the time mode, and as discussed above, these programming inputs include time, delay, and frequency value inputs. In the depth mode, and as discussed above, these programming inputs include outlet pattern, depth, and frequency value inputs. The water management control device 1500 opens and closes the valve 1510 in response to these programming inputs and according to the program sequence.

The water management control device 1500 can optionally include a start button 1558 for initiating a program sequence established by the user-selected programming inputs.

The water management control device 1500 is used as follows. First, the water management control device 1500 is put into either the time mode or the depth mode by moving the blinder plate 1520 to the first position or the second position, as appropriate.

In the time mode, the user sets the user-define programming inputs relating to time, delay, and frequency using the input selectors 1512, 1514, and 1516, as discussed above, to define a program sequence. As part of the program sequence, the water management control device 1500 opens the valve 1510 for the length of time chosen by the user for the time value input. After the length of time chosen has elapsed, the water management control device 1500 closes the valve 1510. If the user selected a delay value input other than zero, the water management control device 1500 waits the length of time chosen for the delay value input before opening the valve 1510 for the length of time chosen. The water management control device 1500 repeats the opening and closing of the valve 1510, including any delay, based on the frequency value input chosen.

In the depth mode, the user sets the user-define programming inputs relating to outlet pattern, depth, and frequency using the input selectors 1512, 1514, and 1516, as discussed above, to define a program sequence. As part of the program sequence, the water management control device 1500 uses the outlet pattern and depth input values to determine an appropriate amount of time to keep the valve 1510 open in order to achieve a watering depth corresponding with the selected depth input value based on the flow characteristics of the water, including the outlet pattern input. The water management control device 1500 can also consider inputs received from a pressure transducer or a flow meter to understand the characteristics of the water being supplied to the water management control device 1500 as part of determining a time. The water management control device 1500 then opens the valve 1510 for determined length of time. After the determined length of time has elapsed, the water management control device 1500 closes the valve 1510. The water management control device 1500 repeats the opening and closing of the valve 1510 based on the frequency value input chosen.

Advantageously, if a start button 1558 is included, the water management control device 1500 initiates the above described program sequences upon actuation of the start button 1558.

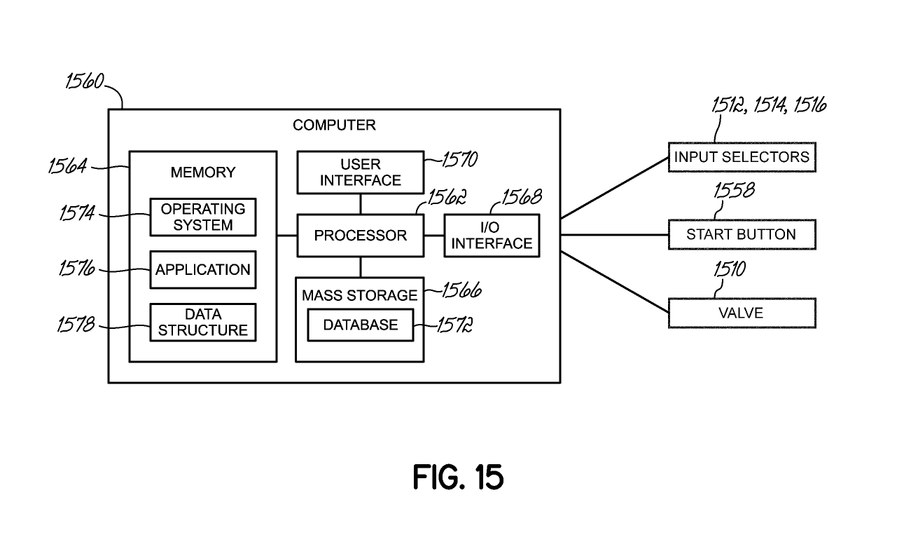

Referring now to FIG. 15, the water management control device 1500 may be implemented on one or more computer devices or systems, such as exemplary computer system 1560. The computer system 1560 may include a processor 1562, a memory 1564, a mass storage memory device 1566, an input/output (I/O) interface 1568, and a user interface 1570.

The processor 1562 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 1564. Memory 1564 may include a single memory device or a plurality of memory devices including but not limited to read-only memory (ROM), random access memory (RAM), volatile memory, non-volatile memory, static random access memory (SRAM), dynamic random access memory (DRAM), flash memory, cache memory, or any other device capable of storing information. The mass storage memory device 1566 may include data storage devices such as a hard drive, optical drive, tape drive, non-volatile solid state device, or any other device capable of storing information. A database 1572 may reside on the mass storage memory device 1566, and may be used to collect and organize data used by the various systems and modules described herein. For example, the database 1572 may contain information that allows the water management control device 1500 to determine an appropriate amount of time to keep the valve 1510 open in order to achieve a watering depth corresponding with the selected depth input value based on the flow characteristics of the water, including the outlet pattern input.

Processor 1562 may operate under the control of an operating system 1574 that resides in memory 1564. The operating system 1574 may manage computer resources so that computer program code embodied as one or more computer software applications, such as application 1576 residing in memory 1564 may have instructions executed by the processor 1562. In an alternative embodiment, the processor 1562 may execute the applications 1576 directly, in which case the operating system 1574 may be omitted. One or more data structures 1578 may also reside in memory 1564, and may be used by the processor 1562, operating system 1574, and/or application 1576 to store or manipulate data.

The I/O interface 1568 may provide a machine interface that operatively couples the processor 1562 to other devices and systems, such as the input selectors 1512, 1514, 1516, the valve 1510, and the start button 1558. The application 1576 may thereby work cooperatively with the input selectors 1512, 1514, 1516 and/or the valve 1510 and/or the start button 1558 and/or a pressure transducer or flow meter by communicating via the I/O interface 1568 to provide the various features, functions, and/or modules comprising embodiments of the invention. The application 1576 may also have program code that is executed by one or more external resources, or otherwise rely on functions and/or signals provided by other system or network components external to the computer system 1560. Indeed, given the nearly endless hardware and software configurations possible, persons having ordinary skill in the art will understand that embodiments of the invention may include applications that are located externally to the computer system 1560, distributed among multiple computers or other external resources, or provided by computing resources (hardware and software) that are provided as a service over a network, such as a cloud computing service.

The user interface 1570 may be operatively coupled to the processor 1562 of computer system 1560 in a known manner to allow a user to interact directly with the computer system 1560. The user interface 1570 may include video and/or alphanumeric displays, a touch screen, a speaker, and any other suitable audio and visual indicators capable of providing information to the user. The user interface 1570 may also include input devices and controls such as an alphanumeric keyboard, a pointing device, keypads, pushbuttons, control knobs, microphones, etc., capable of accepting commands or input from the user and transmitting the entered input to the processor 1562.

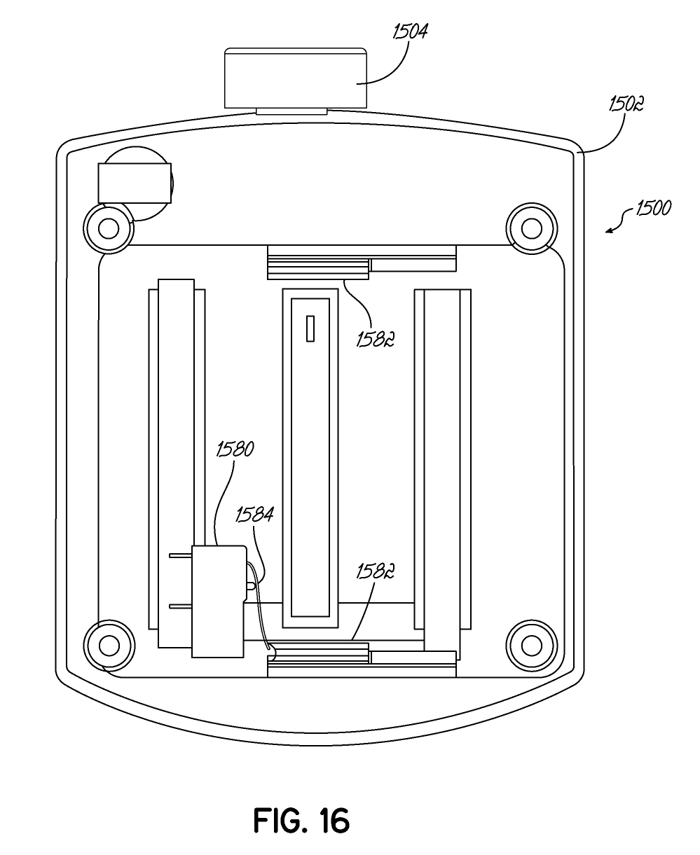

Referring next to FIG. 16, the water management control device 1500 is shown with the body 1502 partially disassembled to show internal components thereof. The water management control device 1500 can include a switch 1580 that cooperates with and is engaged by the blinder plate 1520. The switch 1580 is in a first state when the blinder plate 1520 is in the first position and the water management control device 1500 is operating in the time mode. The switch 1580 is in a second state when the blinder plate 1520 is in the second position and the water management control device 1500 is operating in the depth mode. The switch 1580 is operatively coupled with the computer system 1560 so that the computer system 1560 can know whether the input settings set using the input selectors 1512, 1514, 1516 relate to the time mode or the depth mode, so that the water management control device 1500 can control the valve 1510 accordingly.

In particular, the blinder plate 1520 includes tabs 1582 that can engage a switch arm 1584 of the switch 1580. When the tabs 1582 engage the switch arm 1584, the switch 1580 is put into one of its states, and when the tabs 1582 are moved out of engagement with the switch arm 1584, the switch 1580 is put into the other of its states. The tabs 1582 are moved into and out of engagement with the switch arm 1584 when the blinder plate 1520 is moved between the first and second positions.

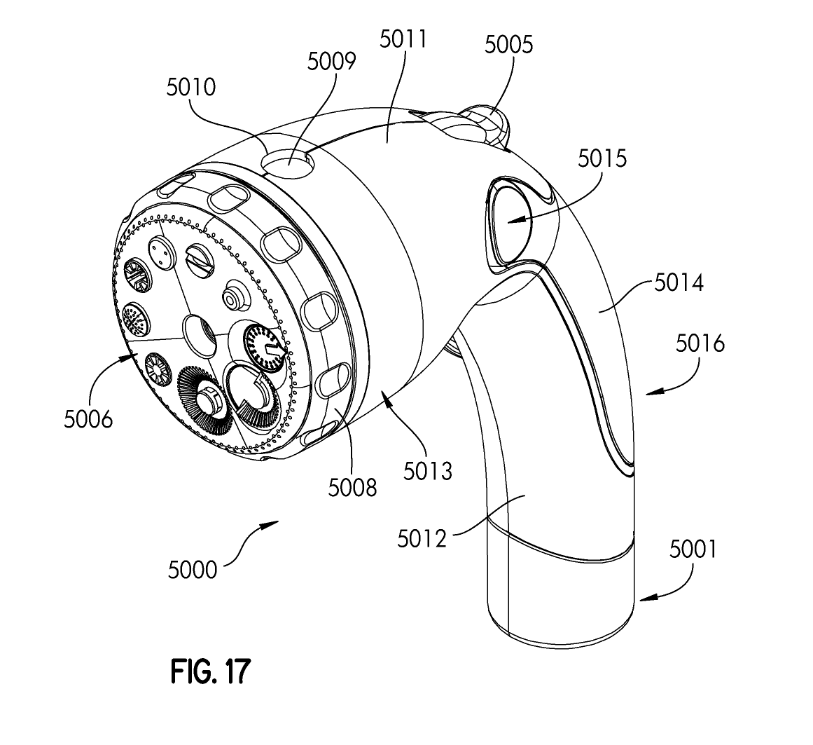

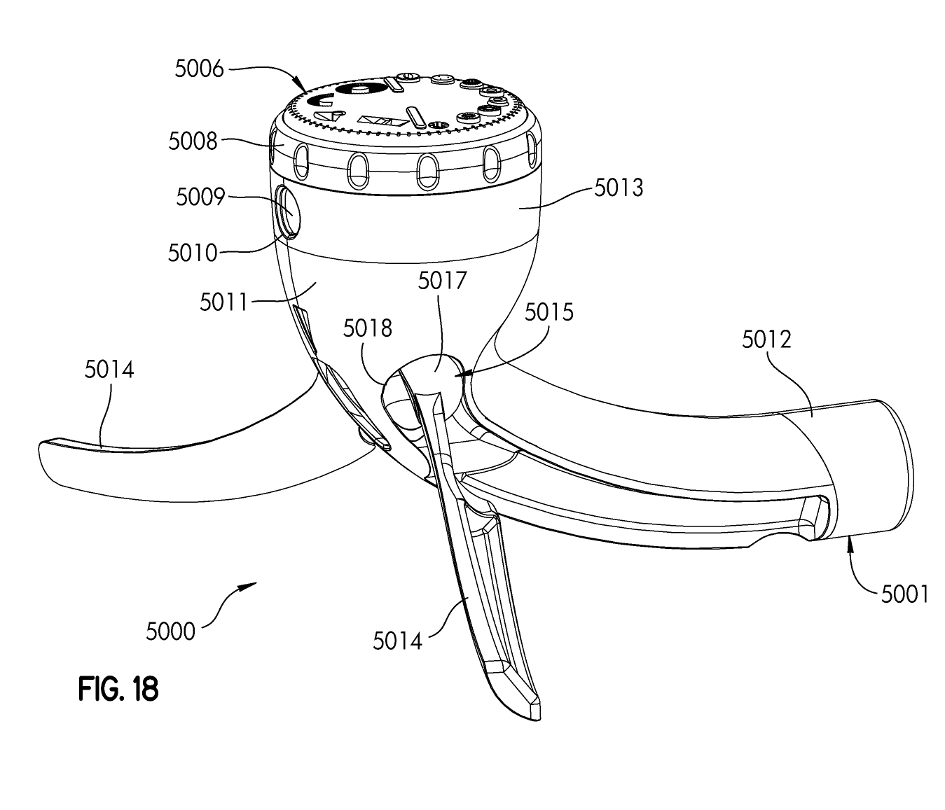

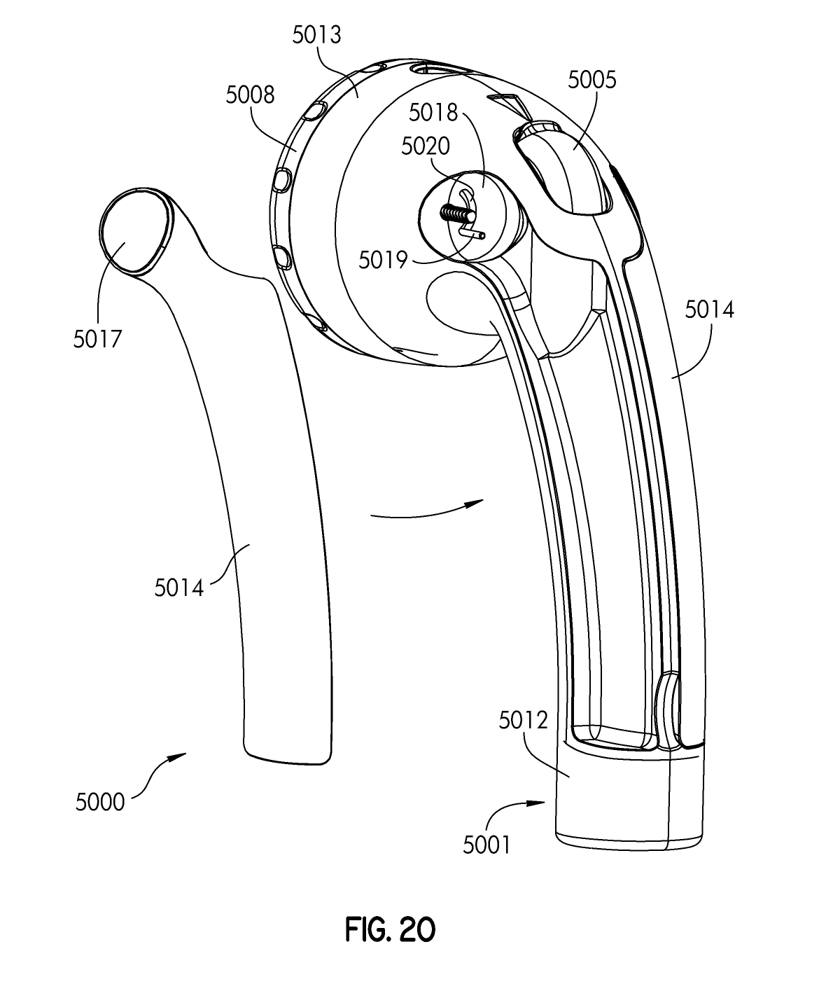

FIGS. 17-20 illustrate another embodiment of a garden watering device 5000. The garden watering device 5000 includes a body member 5012, a discharge head or pistol barrel 5013, and a support structure 5014. The support structure 5014 is coupled to the body member 5012 at a ball and socket-type joint 5015 that allows the support structure 5014 to rotate between a first position flush against the body member 5012 (for handheld operation) and a second position rotated and extending generally away from the body member 5012 (for ground-based operation). Advantageously, the support structure 5014 includes the ball portion of the ball and socket-type joint 5015, and the body member 5012 includes the socket portion, but the opposite is also possible. In the first position (shown in FIG. 17), the support structure 5014 is flush against and cooperates with the body member 5012 to form a generally monolithic handle 5016. Ribs or other surface details (such as a chamfered edge) on support structure 5014, or similar or corresponding surface structure on body member 5012, or combinations thereof, allow for a generally smooth handle 5016. As illustrated in FIGS. 18 and 20, the flush fitting of the support structure 5014 with the body member 5012 is the result of a recess within the body member 5012. In the second position (shown in FIG. 18), the support structure 5014 is rotated away from the body member 5012 and allows the garden watering device 5000 to function as a ground-based sprinkler on any type of ground surface.

With reference to FIG. 20, the support structure 5014 includes a ball portion 5017 at a distal end thereof for mating with a socket portion 5018 formed in the body member 5012 to form the ball and socket-type joint 5015. The ball portion 5017 engages a pin 5019 that rides in a track 5020. Thereby, rotational movement of the support structure 5014 is defined and limited by the interaction between the pin 5019 and the track 5020. As the 5014 moves from the first position to the second position, the ball and socket-type joint 5015 provides for movement of the support structure 5014 along a generally arcuate path.

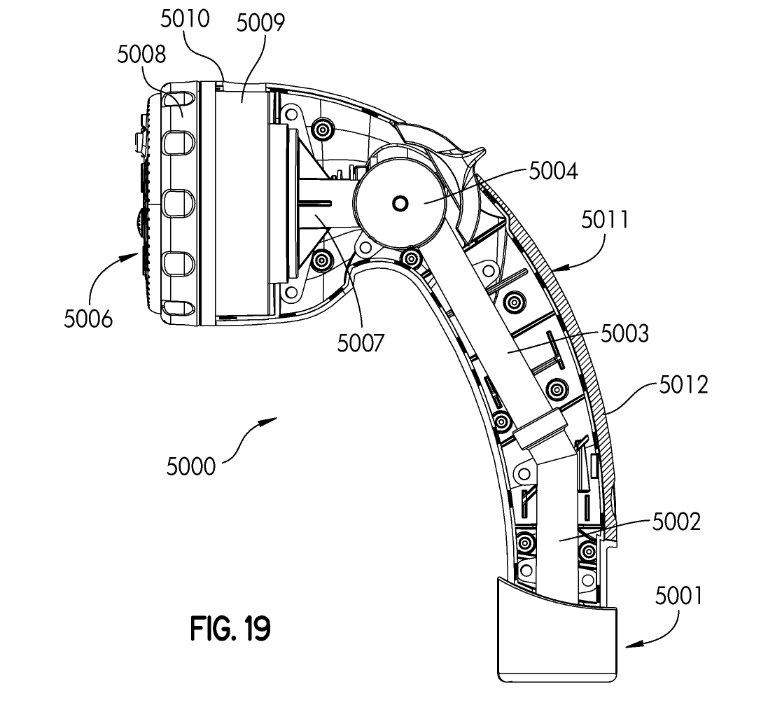

As shown in FIG. 19, the garden watering device 5000 includes a hose end 5001 that is in fluid communication with a lower flow path 5002, which in turn, is in fluid communication with an upper flow path 5003. Connected to the upper flow path 5003 is a control valve 5004 which is actuated by a trigger 5005. The control valve 5004 allows a user to selectively control the flow of water to a spray dial 5006, which is a multi-pattern spray head. The control valve 5004 is in turn in communication with an internal spray bowl 5007 which collects and conveys water to the spray dial 5006. An accent ring 5008 is located around the spray dial 5006 and offers an attractive and dedicated area by which the user can change the position and setting of the spray dial 5006. The dial setting is presented to the user by an indicia ring 5009, which provides indicia corresponding to a selected setting through an indicia window 5010. The indicia ring 5009 allows the user the ability to view and change the setting of the spray dial 5006 without being required to look at the face of the dial and to do so from a convenient operational position of the garden watering device 5000. The garden watering device 5000 generally includes a device housing 5011, for containing various components of the garden watering device 5000.

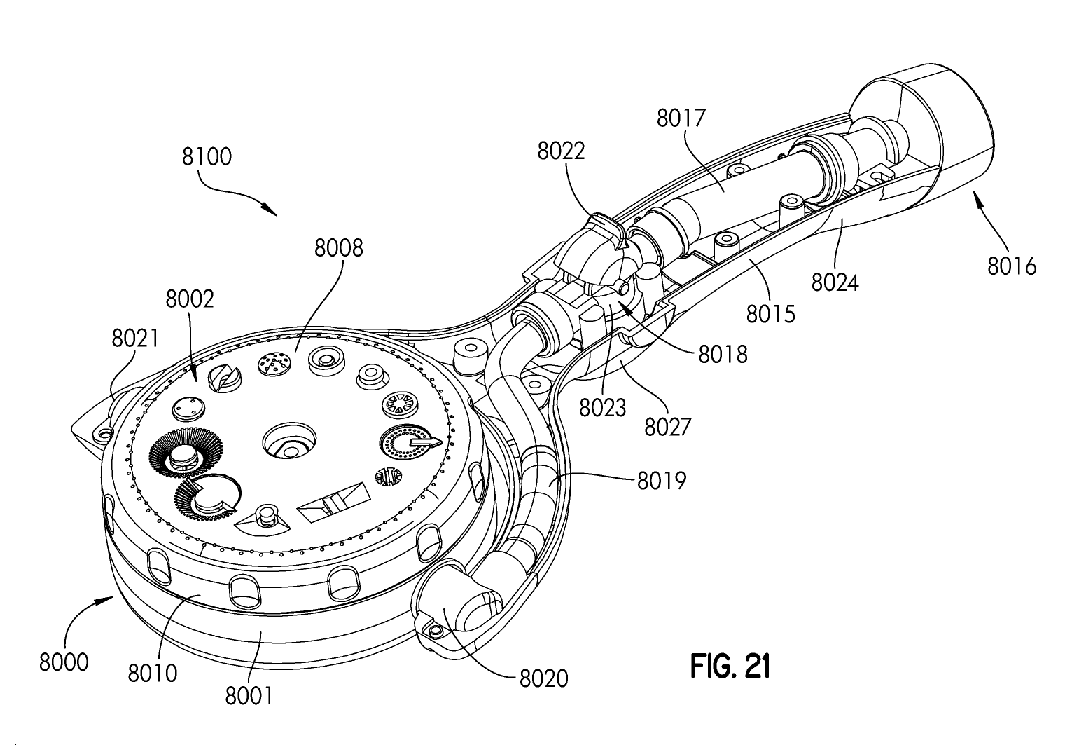

FIGS. 21-23 illustrate another embodiment of a garden watering device 8100. The garden watering device 8100 contains a main housing 8015, a spray head 8000, a hose end 8016, a lower flow path 8017, a valve assembly 8018, an upper flow path 8019, a rotatable coupling 8020, a ratcheting mechanism 8021, and a handle portion 8024. The rotatable coupling provides a rotatable coupling for the spray head 8000 and a passageway therethrough for the water to flow to the spray head 8000. Water flows into the garden watering device 8100 through the hose end 8016 into the lower flow path 8017 up to the valve assembly 8018 and then, selectively, into the upper flow path 8019. The water then flows past the rotatable coupling 8020 and into a dial assembly 8002 and out a spray dial 8008. The valve assembly 8018 includes a trigger 8022 that allows a user to selectively control the flow of water to the spray head 8000 and a valve body 8023. The spray head 8000 is rotatably coupled to the main housing 8015 by the rotatable coupling 8020 such that it can be rotated relative to the main housing 8015 while maintaining fluid communication with the upper flow path 8019. The angle of the spray head 8000 relative to the main housing 8015 is maintained by the ratcheting mechanism 8021, and is configured such that the user can adjust the angle manually, with the ratcheting mechanism 8021 generally preventing unintentional adjustment of the spray head 8000. Advantageously, the spray head 8000 is capable of spraying water over a wide range of angles with respect to the main housing 8015. Additionally, in the embodiment shown the main housing 8015 does not encircle the spray head 8000 so as to not interfere with water spraying therefrom.

The spray head 8000 includes a main body 8001, a dial assembly 8002, an indicia dial 8003, a housing cover 8004, a flow channel cover 8005, a flow channel gasket 8006, and a dial gasket 8007. The dial assembly 8002 includes spray dial 8008, a dial backer plate 8009, and an accent ring 8010. The spray dial 8008 and dial backer plate 8009 are connected in such a way as to form a water tight union between the two. The water flows in to the spray head 8000 via an inlet hole 8011, through an internal flow channel 8012, up to a main body outlet hole 8013, through the dial gasket 8007, to the dial assembly 8002, through the dial backer plate 8009, into, and then out of, the spray dial 8008. The dial gasket 8007 ensures a substantially watertight connection between the main body outlet hole 8013 and the dial backer plate 8009. The internal flow channel 8012 is enclosed by a flow channel cover 8005, with the flow channel gasket 8006 being positioned between the two parts to help ensure a water tight fit. A tang 8024 of the indicia dial 8003 is inserted through the main body 8001 and into the dial assembly 8002, such that the dial assembly 8002 and the indicia dial 8003 turn in unison. The indicia dial 8003 includes graphics or other indicia that present to the user the selected outlet on the spray dial 8008 in a position that is more easily viewed by the user when the sprinkler is in use. The housing cover 8004 encloses the indicia dial 8003 and the bottom of the spray head 8000 to protect and selectively obscure the user's view of the indicia on the dial 8003 that do not correspond with the dial's selected setting. The unobscured portion of the indicia dial 8003 (corresponding with the dial's selected setting) is viewable through the housing cover 8004 through an indicia window 8014.

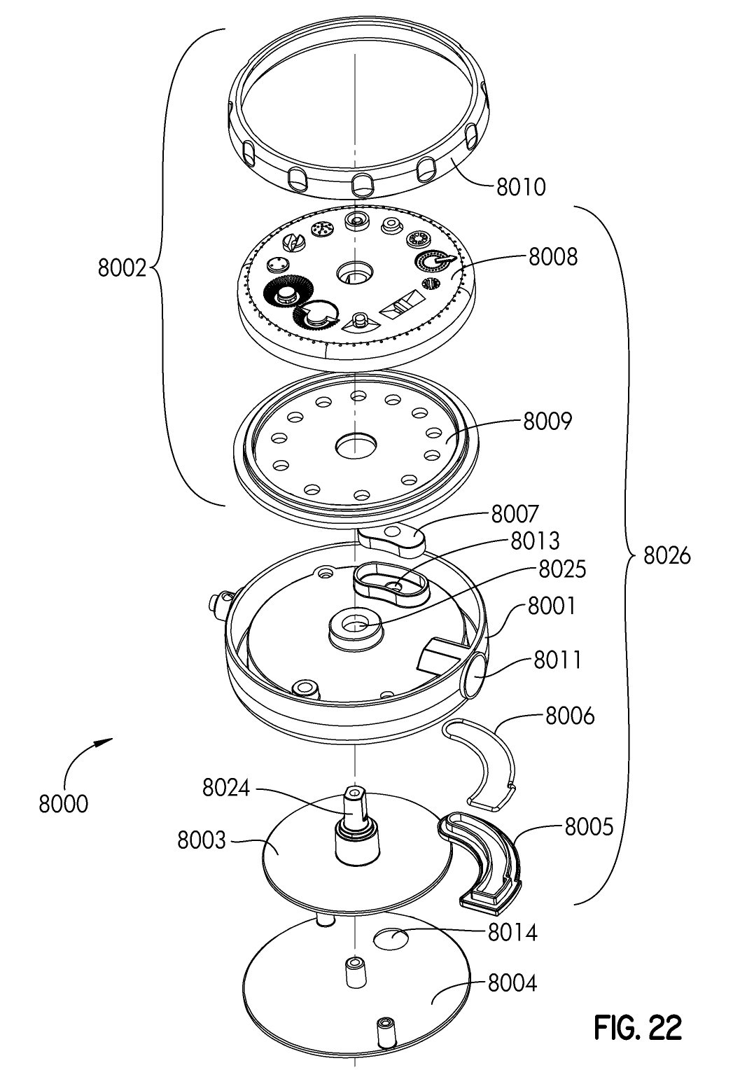

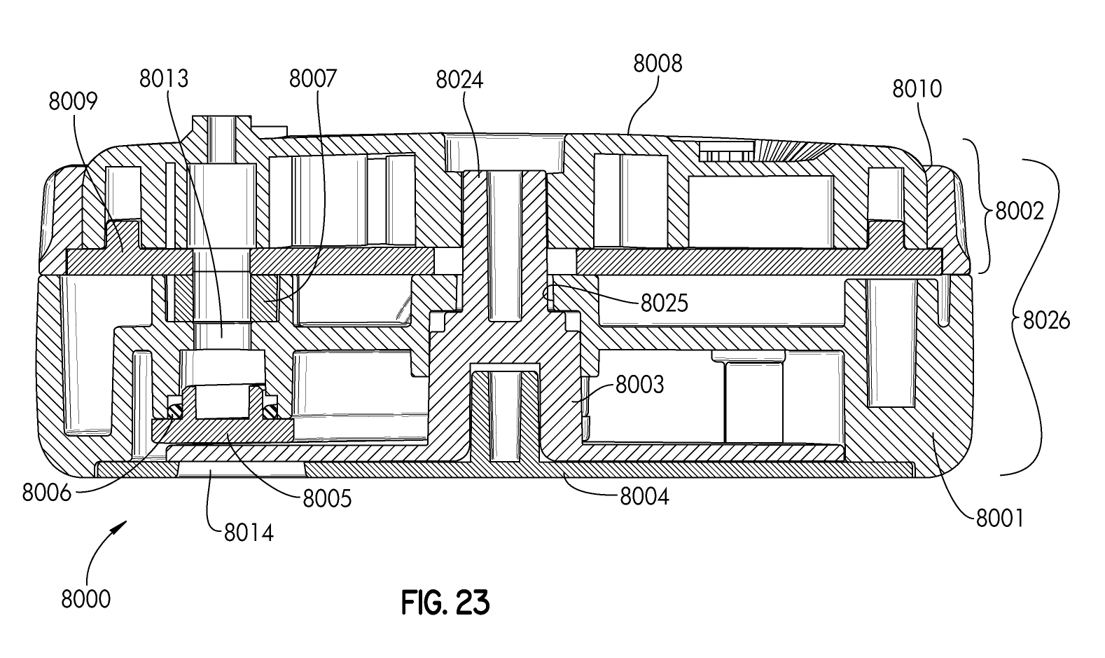

As shown in FIGS. 22 and 23, a dial-indicia assembly 8026 includes the spray dial 8008, the indicia dial 8003, the main body 8001, and the dial backer plate 8009. The spray dial 8008 is connected to the indicia dial 8003 through the tang 8024 that extends from the indicia dial 8003 through a hole 8025 formed within the main body 8001 through the backer plate 8009 and into the spray dial 8008. The tang 8024 is indexed with the dial 8003 to allow both the spray dial 8008 and the indicia dial 8003 to turn in unison. The hole 8025 allows for free rotation of both the spray dial 8008 and the indicia dial 8003. The internal flow channel 8012 extends along a curved path within the main body 8001, which main body 8001 is configured so that the flow path 8012 is not compromised or interrupted by the dial-indicia assembly 8026. Since the flow path 8012 is not compromised by the tang 8024, little to no additional sealing structures are needed around the tang 8024 to form a water tight union between the tang 8024 and the hole 8025.

Advantageously, the main housing 8015 includes a bulge 8027 generally in the vicinity of the valve assembly 8018, and generally near a region of the handle portion 8024 away from the hose end 8016. The bulge 8027 is generally opposite the valve assembly trigger 8022, and serves as a finger-locating structure so that a user can solidly grip the handle portion 8024 and engage the trigger 8022. As used herein, the term “bulge” generally refers to the rounded swelling portion that extends outward from the otherwise generally consistent shape of the handle portion 8024, as indicated at 8027. The bulge 8027 may generally correspond with the increased space requirements of the valve assembly 8018.

During ground-based operation, a tripedal support is provided for the watering device 8100 generally by the handle portion 8024, the bulge 8027, and the spray head 8000 or components of the main housing 8015 that support the spray head 8000. Thus, the size and shape of the bulge 8027 should be taken with the ground-based operation of the watering device 8100 in mind, and the size and shape should be chosen to provide an appropriate support of the watering device 8100.

While the present invention has been illustrated by a description of various preferred embodiments and while these embodiments have been described in some detail, it is not the intention of the applicant to restrict or in any way limit the scope of the appended claims to such detail. Additional advantages and modifications will readily appear to those skilled in the art. The various features of the invention may be used alone or in numerous combinations depending on the needs and the preferences of the user.

What is claimed is:

1. A water management control device configured to operate in a time mode and a depth mode to control the flow of water through an internal passageway based on user-selected programming inputs relating to watering by time or watering by depth.

2. A water management control device as disclosed herein.

3. A method of operating a water management control device as disclosed herein.
